(19) United States
(12) Patent Application Publication
(10) Pub. No.: US 2011/0285886 A1
(43) Pub. Date: Nov. 24, 2011

(54) SOLID-STATE IMAGE SENSOR, CAMERA SYSTEM AND METHOD FOR DRIVING THE SOLID-STATE IMAGE SENSOR

(75) Inventors: Yoshihisa KATO, Shiga (JP); Hiroyoshi KOMOBUCHI, Kyoto (JP); Takeo AZUMA, Kyoto (JP); Kazuya YONEMOTO, Kanagawa (JP)

(73) Assignee: PANASONIC CORPORATION, Osaka (JP)

(21) Appl. No.: 13/197,038

(22) Filed: Aug. 3, 2011

Related U.S. Application Data
(63) Continuation of application No. PCT/JP2009/005591, filed on Oct. 23, 2009.

(30) Foreign Application Priority Data
Feb. 5, 2009 (JP) 2009-025123

(51) Int. Cl. H04N 5/335

(52) U.S. Cl. 348/297; 348/E05.091

(57) ABSTRACT

The solid-state image sensor of the present invention includes: multiple different types of pixel groups, which exhibit mutually different sensitivity properties that vary from one group to another according to wavelengths of incoming light, wherein each pixel has a photoelectric converter for outputting a pixel signal that changes with the intensity of the light received, and a reading circuit, which reads the pixel signal from each of the multiple types of pixel groups and which outputs an image signal representing an image that is associated with the type of a pixel group. The reading circuit outputs the image signal with the frame frequency changed according to the type of the pixel group.

This is a continuation of International Application No. PCT/JP2009/005591, with an international filing date of Oct. 23, 2009, which claims priority of Japanese Patent Application No. 2009-025123, filed on Feb. 5, 2009, the contents of which are hereby incorporated by reference.

### BACKGROUND OF THE INVENTION

1. Field of the Invention

The present invention relates to a solid-state image sensor, a camera system and a driving method. More particularly, the present invention relates to a solid-state image sensor for capturing a high-resolution, high-frame-rate moving picture with high sensitivity, a camera system including such a solid-state image sensor, and a method for driving such a solid-state image sensor.

2. Description of the Related Art

Widespread transition to digital broadcasting systems have been occurred around the world, images with higher resolutions can now be displayed on a high-definition TV monitor. Meanwhile, camcorders that can capture a moving picture with a resolution of 2 megapixels, which is almost as high as that of a professional use broadcasting system, have also been increasingly popular nowadays among general consumers. Such a resolution increasing trend seems to continue for the future, because people are now discussing standards for even higher resolutions of 8 megapixels (which is so-called ““4K2K format”) and 32 megapixels (which is so-called “8K4K format”).

A solid-state image sensor that is typically used in those camcorders of today is an MOS (metal-oxide semiconductor) type. FIG. 30 illustrates a configuration for such an image sensor. As shown in FIG. 30, a number of pixels 11, which have sensitivities in respective wavelength ranges associated with the three primary colors (red (R), green (G) and blue (B)) of light, are arranged as a two-dimensional matrix, which is surrounded with a vertical shift register 12 and a horizontal shift register 13 that do scanning.

The solid-state image sensor reads pixel signals from one pixel after another with a group of lines that run in the row direction activated, performs the same operation a number of times vertically to make a vertical scan, and then makes the horizontal shift register 13 transfer the pixel signal horizontally, thereby outputting two-dimensional image information serially. When pixel signals associated with respective color filters are read, a red (R) image, a green (G) image and a blue (B) image can be obtained. FIG. 31 illustrates R, G and B signals that have been output from the image sensor. A single image is called a “frame”. That is to say, three frames of the red (R), green (G) and blue (B) images form one frame of a color image. Thus, by reading multiple frames continuously with respect to each of the R, G and B images, a moving picture can be shot. In this description, the period of time it takes to output one frame will be referred to herein as “one frame period” and the number of frames output per second will be referred to herein as a “frame frequency”.

If a high-illuminance subject has been shot in a bright shooting environment, the pixel signal may be read from every pixel and R, G and B images with a full resolution may be output as shown in FIG. 31. On the other hand, if a low-illuminance subject is shot in a dark shooting environment, then the pixel signal output from each pixel will have a decreased level.

To shoot a subject with high sensitivity even at such a low illuminance, according to a known method, a decrease in sensitivity is minimized by decreasing the frame frequency so that each photodiode 21 is irradiated with light for a longer time (i.e., the exposure time is increased). Or, according to another known method, pixel signals output from multiple pixels are added together by a signal adder 17 and the sum is output as a signal with an increased level (which is so-called “binning processing”).

FIG. 32 illustrates an example of images to be output when the R, G and B images shown in FIG. 31 are subjected to the binning processing. For example, if four pixels are added together for each of the R, G and B images, then the vertical and horizontal resolutions will decrease to a half, but the sensitivity can be increased fourfold, compared to the example illustrated in FIG. 31. As a result, a moving picture can be shot with high sensitivity.

Such a technique for increasing the sensitivity by adding multiple pixels together under a low illuminance is disclosed in Japanese Patent Application Laid-Open Publication No. 2004-312140, for example. Strictly speaking, however, when their pixels are added together, the spatial phases of the R, G and B images will be different from each other by approximately one pixel. Nevertheless, it should be noted that as FIG. 32 illustrates just conceptually how that pixel adding technique works, their spatial phases are illustrated as agreeing with each other. The same statement will apply to any of the other drawings that illustrate the pixel adding technique and that will be referred to later in this description.

According to the conventional method for shooting a moving picture with high sensitivity under a low illuminance, however, either the frame frequency or the resolution should be sacrificed. Specifically, if the method for increasing the exposure time is adopted, the frame frequency decreases. On the other hand, according to the method that uses the binning processing, the resolution decreases.

### SUMMARY OF THE INVENTION

It is therefore an object of the present invention to shoot a moving picture with high sensitivity, high frame frequency and high resolution even under a low illuminance.

A solid-state image sensor according to the present invention includes: multiple different types of pixel groups, which exhibit mutually different sensitivity properties that vary from one group to another according to wavelengths of incoming light, wherein each pixel has a photoelectric converter for outputting a pixel signal in accordance with intensity of the light received, and a reading circuit, which reads the pixel signal from each of the multiple types of pixel groups and which outputs an image signal representing an image that is associated with the type of a pixel group. The reading circuit reads the pixel signal and outputs the image signal with the frame frequency changed according to the type of the pixel group.

The solid-state image sensor may further include a signal adder for adding together multiple pixel signals that have been read from the same type of pixel group. The signal adder may change the number of the pixel signals to add together according to the type of the pixel group, thereby changing the spatial frequency of the image with the type of pixel group.

At least three types of pixel groups, which are included in the multiple different types of pixel groups, may respectively have three photoelectric converters that exhibit the highest sensitivity to red, green and blue incident light rays. Two images that have been respectively read from a red pixel group that exhibits the highest sensitivity to the red light ray and from a blue pixel group that exhibits the highest sensitivity to the blue light ray may have higher frame frequencies than an image that has been read from a green pixel group that exhibits the highest sensitivity to the green light ray.

The two images that have been respectively read from the red and blue pixel groups may have lower spatial frequencies than the image that has been read from the green pixel group.

At least four types of pixel groups, which are included in the multiple different types of pixel groups, may respectively have three photoelectric converters that exhibit the highest sensitivity to red, green and blue incident light rays and another photoelectric converter that exhibits high sensitivity over the entire visible radiation range. An image that has been read from a white pixel group that exhibits the high sensitivity over the entire visible radiation range may have a higher frame frequency than an image that has been read from any of red, blue and green pixel groups that exhibit the highest sensitivity to the red, blue and green light rays, respectively.

The image that has been read from the white pixel group may have a lower spatial frequency than the image that has been read from any of the red, green and blue pixel groups.

At least four types of pixel groups, which are included in the multiple different types of pixel groups, may respectively have a photoelectric converter that exhibits the highest sensitivity to the green incident light ray and three photoelectric converters that exhibit the highest sensitivity to incident light rays representing the three complementary colors of the three primary colors. An image that has been read from any of three types of complementary color pixel groups representing the complementary colors may have a higher frame frequency than an image that has been read from a green pixel group that exhibits the highest sensitivity to the green light ray.

The image that has been read from any of the three types of complementary color pixel groups may have a lower spatial frequency than the image that has been read from the green pixel group.

A camera system according to the present invention includes: a solid-state image sensor according to any of the preferred embodiments of the present invention described above; a motion detector for calculating the motion of a subject based on an image frame with a relatively high frame frequency that has been read from the solid-state image sensor; and a restoration processor for generating an interpolated frame between image frames with a relatively low frame frequency that have been read from the solid-state image sensor.

The restoration processor may restore the shape of the subject using an image frame with a relatively high spatial frequency that has been read from the solid-state image sensor, and may generate an interpolated pixel with respect to an image frame with a relatively low spatial frequency that has also been read from the solid-state image sensor.

The camera system may further include a timing generating section for controlling the frame frequency of an image to be read according to the type of the pixel group by changing the operating frequency of a reading circuit that is reading the image with the brightness of the subject.

The camera system may further include another timing generating section for controlling the spatial frequency of an image according to the type of the pixel group by changing the number of pixel signals to be added together by the signal adder with the brightness of the subject.

A reading method according to the present invention is a method for reading an image signal from a solid-state image sensor with multiple different types of pixel groups, which exhibit mutually different sensitivity properties. Each of the pixels that form the multiple different types of pixel groups has a sensitivity property that varies according to wavelengths of incoming light and also has a photoelectric converter for outputting a pixel signal that changes with the intensity of the light received. The method includes the steps of: exposing the photoelectric converter with the exposure time changed according to the type of the pixel group; reading the pixel signal from each of the multiple types of pixel groups, the pixel signal representing the intensity of light that has been received for one of multiple different exposure times; and outputting an image signal representing an image according to what type of pixel group with the frame frequency changed according to the type of the pixel group.

The reading method may further include the step of adding together multiple pixel signals that have been read from the same type of pixel group. The step of adding may include changing the number of pixel signals to add together according to the type of the pixel group. And the step of outputting an image signal may include outputting, based on the pixel signals that have been added together, an image signal representing an image, of which the spatial frequency varies according to the type of the pixel group.

At least three types of pixel groups, which are included in the multiple different types of pixel groups, may respectively have three photoelectric converters that exhibit the highest sensitivity to red, green and blue incident light rays. Red and blue pixel groups that exhibit the highest sensitivity to the red and blue light rays, respectively, may have a shorter exposure time than a green pixel group that exhibits the highest sensitivity to the green light ray. The step of outputting the image signal may include outputting image signals representing three images that have been read from the green, red and blue pixel groups, respectively. And the two images that have been respectively read from the red and blue pixel groups may have higher frame frequencies than the image that has been read from the green pixel group.

The reading method may further include the step of adding together multiple pixel signals that have been read from the same type of pixel group. As the step of adding includes changing the number of pixel signals to add together according to the type of the pixel group, the number of pixel signals that have been read from each of the red and blue pixel groups may be larger than that of pixel signals that have been read from the green pixel group. The two images that have been respectively read from the red and blue pixel groups may have lower spatial frequencies than the image that has been read from the green pixel group.

At least four types of pixel groups, which are included in the multiple different types of pixel groups, may respectively have three photoelectric converters that exhibit the highest sensitivity to red, green and blue incident light rays and another photoelectric converter that exhibits high sensitivity over the entire visible radiation range. Red, blue and green pixel groups that exhibit the highest sensitivity to the red, blue and green light rays, respectively, may have a shorter exposure time than a white pixel group that exhibits the high sensitivity over the entire visible radiation range. The step of outputting the image signal may include outputting image signals representing four images that have been read from the green, red, blue and white pixel groups, respectively. The respective images that have been read from the red, blue and green pixel groups may have higher frame frequencies than the image that has been read from the white pixel group.

The reading method may further include the step of adding together multiple pixel signals that have been read from the same type of pixel group. As the step of adding includes changing the number of pixel signals to add together according to the type of the pixel group, the number of pixel signals that have been read from each of the red, blue and green pixel groups may be larger than that of pixel signals that have been read from the white pixel group. The three images that have been respectively read from the red, blue and green pixel groups may have lower spatial frequencies than the image that has been read from the white pixel group.

At least four types of pixel groups, which are included in the multiple different types of pixel groups, may respectively have a photoelectric converter that exhibits the highest sensitivity to the green incident light ray and three photoelectric converters that exhibit the highest sensitivity to incident light rays representing the three complementary colors of the three primary colors. Three types of complementary color pixel groups that are associated with the three complementary colors, respectively, may have a shorter exposure time than the green pixel group that exhibits the highest sensitivity to the green light ray. And an image that has been read from any of the three types of complementary color pixel groups may have a higher frame frequency than an image that has been read from the green pixel group.

The reading method may further include the step of adding together multiple pixel signals that have been read from the same type of pixel group. As the step of adding includes changing the number of pixel signals to add together according to the type of the pixel group, the number of pixel signals that have been read from each of the three types of complementary color pixel groups may be larger than that of pixel signals that have been read from the green pixel group. The three images that have been respectively read from the three types of complementary color pixel groups may have lower spatial frequencies than the image that has been read from the green pixel group.

A signal processing method according to the present invention is performed by a signal processor in a camera system that includes: multiple different types of pixel groups, which exhibit mutually different sensitivity properties that vary from one group to another according to wavelengths of incoming light, wherein each pixel has a photoelectric converter for outputting a pixel signal in accordance with intensity of the light received; and the signal processor for processing an image that has been read from the solid-state image sensor. The method includes the steps of: calculating the motion of a subject based on an image with a high frame frequency that has been read from the solid-state image sensor by a reading method according to any of the preferred embodiments described above; and generating an interpolated frame between images with a low frame frequency.

The signal processing method may further include the steps of: calculating the shape of the subject using the image with the high spatial frequency that has been read from the solid-state image sensor; and interpolating a pixel with respect to the image with the low spatial frequency that has also been read from the solid-state image sensor based on the shape calculated.

The signal processing method may further include the step of controlling the frame frequency on a pixel group basis by changing the exposure time with the type of the pixel group and according to the brightness of the subject.

The signal processing method may further include the step of adding together multiple pixel signals that have been read from the same type of pixel group. The step of adding may include controlling the spatial frequency of an image according to what type of pixel group is going to be processed among the multiple types by changing the number of pixel signals to add together with the type of the pixel group and according to the brightness of the subject.

According to the present invention, a color image can be captured with high resolution, high frame frequency and high sensitivity.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIGS. 1A and 1B illustrate the appearances of a digital still camera 100a and a camcorder 100b.

FIG. 2 illustrates a hardware configuration for a camera system 100.

FIG. 3 illustrates a configuration for a solid-state image sensor 81 as a first preferred embodiment of the present invention.

FIG. 4 illustrates a circuit configuration for each pixel 11.

FIG. 5 shows the photoelectric conversion properties 31, 32 and 33 of R, G and B pixels.

FIG. 6 shows the drive timings of pulses to be applied from a vertical shift register 11 to respective lines during one frame period of a read operation and also shows how potentials on vertical signal lines VSL vary during that period.

FIG. 7 illustrates a configuration for a camera system in which a signal processor 82 and a timing generator (TG) 83 are connected to the output terminal SIGOUT of the solid-state image sensor 81.

FIG. 8 shows the drive timings of pulses to be applied in such a situation where only the TRANR and TRANS lines are activated in the (4n−2)^{th}, (4n−1)^{th} and 4n^{th} frames.

FIG. 9 illustrates a configuration for a portion of a signal adder 17 that is used to process two columns of pixels.

FIG. 10 illustrates a configuration for a portion of another signal adder that is used to process two columns of pixels.

FIG. 11 illustrates respective image frames that have been output from the image sensor (i.e., the solid-state image sensor 81).

FIG. 12 illustrates R, G and B images to be output from the signal processor 82 with the full resolution and at high frame frequencies.

FIG. 13 is a block diagram illustrating a configuration for a camera system 100 according to the first preferred embodiment.

FIG. 14 illustrates a more detailed configuration for the signal processor 82.

FIGS. 15A and 15B respectively illustrate a base frame (which is an image at a time t) and a reference frame (which is an image at a time t+Δt) for use to detect a motion by block matching.

FIGS. 16A and 16B show virtual sample points in a situation where spatial addition is performed on 2×2 pixels, wherein FIG. 16A illustrates an example in which four pixels are added together and FIG. 16B illustrates virtual sample points set by the spatial addition.

FIG. 17 illustrates an exemplary configuration for a restoration processor 202.

FIG. 18 illustrates an exemplary correspondence between the RGB color space and the spherical coordinate system (θ, ψ, r).

FIG. 19 illustrates luminance (Y) images, Pb images and Pr images to be output by the signal processor 82.

FIG. 20 illustrates a configuration for a solid-state image sensor 92 as a second preferred embodiment of the present invention.

FIG. 21 shows how different the photoelectric conversion property 91 of W pixels and the photoelectric conversion properties 31, 32 and 33 of R, G and B pixels are.

FIG. 22 illustrates frames of respective images that have been output by the image sensor (i.e., the solid-state image sensor 92).

FIG. 23 illustrates R, G and B images to be output from the signal processor 82 with the full resolution and at high frame frequencies.

FIG. 24 illustrates a configuration for a solid-state image sensor 93 as a third preferred embodiment of the present invention.

FIG. 25 illustrates frames of respective images that have been output by the image sensor (i.e., the solid-state image sensor 92).

FIG. 26 illustrates R, G and B images to be output from the signal processor 82 with the full resolution and at high frame frequencies.

FIG. 27 is a diagram illustrating a pixel circuit consisting of four rows and two columns of pixels in a solid-state image sensor as a fourth preferred embodiment of the present invention.

FIG. 28 illustrates a configuration for a solid-state image sensor 94 as a fifth preferred embodiment of the present invention.

FIG. 29 is a circuit diagram for a pixel as a constituent element of the solid-state image sensor 94.

FIG. 30 illustrates a configuration for an image sensor.

FIG. 31 illustrates R, G and B signals that have been output from the image sensor.

FIG. 32 illustrates an example of images to be output when the R, G and B images shown in FIG. 31 are subjected to binning processing.

### DETAILED DESCRIPTION OF PREFERRED EMBODIMENTS

Hereinafter, preferred embodiments of a solid-state image sensor, a camera system, and a method for driving the solid-state image sensor according to the present invention will be described with reference to the accompanying drawings.

First of all, a preferred embodiment of a camera system according to the present invention and preferred embodiments of a solid-state image sensor to form part of the camera system and its driving method will be described as a first preferred embodiment of the present invention. After that, variations of the solid-state image sensor and their driving methods will be described as second through fifth preferred embodiments of the present invention.

Optionally, the camera system of the present invention may also use the solid-state image sensor of any of the second through fifth preferred embodiments instead of the solid-state image sensor of the first preferred embodiment. However, description of such a camera system with any of those different combinations than the first preferred embodiment will be omitted herein to avoid redundancies.

### Embodiment 1

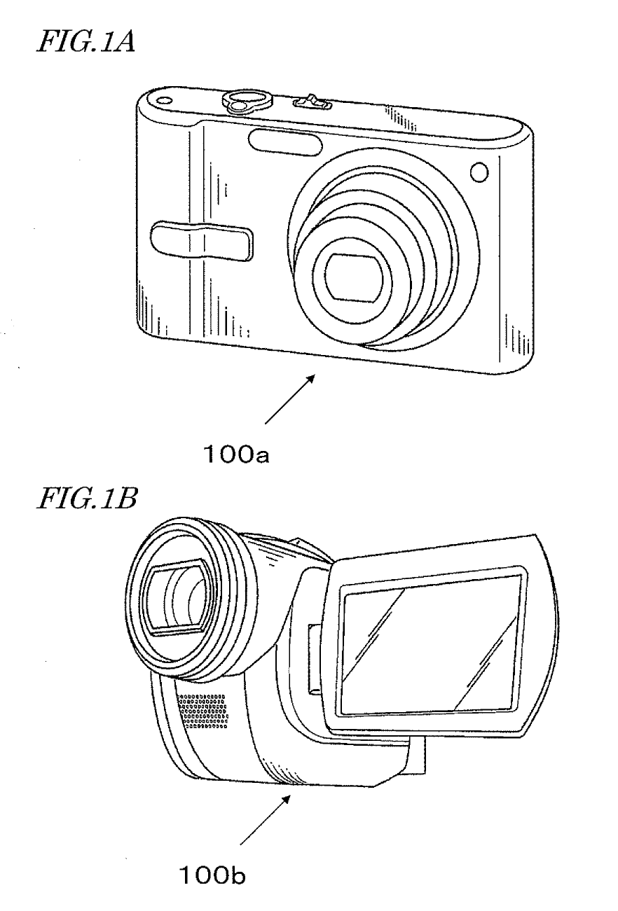

FIGS. 1A and 1B illustrate the appearances of a digital still camera 100a and a camcorder 100b as preferred embodiments of camera systems according to the present invention. The digital still camera 100a is used mostly to shoot a still picture but also has the capability of shooting a moving picture. On the other hand, the camcorder 100b is used mostly to shoot a moving picture.

In this description, the digital still camera 100a and the camcorder 100b will be collectively referred to herein as “camera systems 100”.

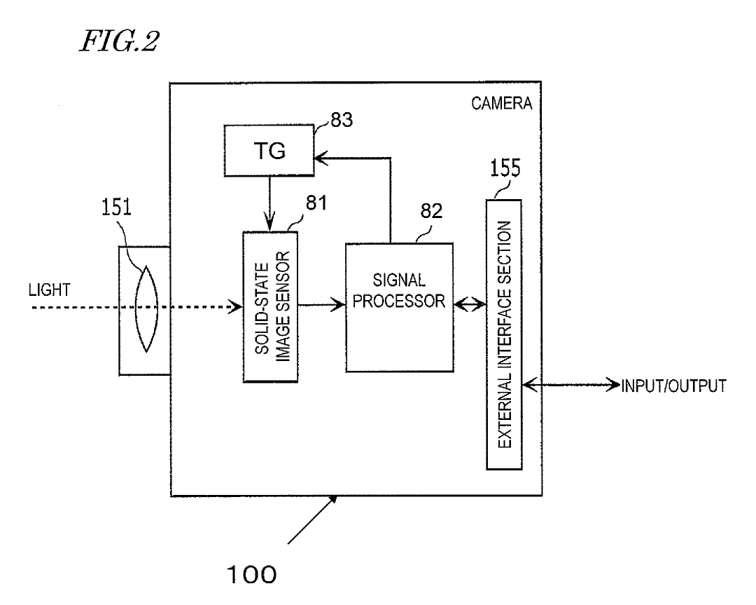

FIG. 2 illustrates a hardware configuration for the camera system 100 of this preferred embodiment.

The camera system 100 includes a lens 151, a solid-state image sensor 81, a timing generator (which will be sometimes simply referred to herein as “TG”) 83, a signal processor 82 and an external interface section 155.

The light that has been transmitted through the lens 151 is incident on the solid-state image sensor 81, which is a single-panel color image sensor. The signal processor 82 gets the solid-state image sensor 81 driven by the timing generator 83 and receives an output signal from the solid-state image sensor 81.

The solid-state image sensor 81 of this preferred embodiment has multiple different types of pixel groups. As used herein, the “multiple different types of pixel groups” refer to a number of pixel groups with their own photoelectric converters, which exhibit mutually different sensitivity properties that vary from one group to another according to wavelengths of incoming light. For example, three pixel groups, the sensitivity properties of which are associated with the colors red (R), green (G) and blue (B), may be used as the multiple different types of pixel groups.

The solid-state image sensor 81 can read pixel signals that have been generated by those multiple different types of pixel groups independently of each other. As a result, image signals can be obtained, and images (i.e., frames) can be generated, on a sensitivity property basis. In this description, images obtained from three pixel groups, of which the sensitivity properties are associated with the colors red (R), green (G) and blue (B), will be referred to herein as an “R image”, a “G image” and a “B image”, respectively.

The pixel signal reading method (i.e., the method for driving the solid-state image sensor 81) of this preferred embodiment is partly characterized by reading the image signals so that an image that has been obtained from one pixel group with a particular sensitivity property has a different frame frequency from any of the images that have been obtained from the other pixel groups.

Specifically, the solid-state image sensor 81 reads respective images so that the R and B images have higher frame frequencies than the G image. As for the resolution, on the other hand, the solid-state image sensor 81 reads respective images so that the G image has a higher resolution than the R and B images.

The signal processor 82 subjects the output signals of those multiple different types of pixel groups to various kinds of signal processing.

The signal processor 82 detects the motion of the subject based on the R and B images that have been supplied at high frame frequencies and generates an interpolated frame for the G image, thereby increasing the frame frequency of the G image. At the same time, the signal processor 82 also generates interpolated pixels for the R and B images based on the G image that has been supplied with the full resolution, thereby increasing the resolutions of the R and B images.

And the signal processor 82 outputs those image signals with such high resolutions and high frame frequencies to an external device through the external interface section 155. As a result, a color image can be captured with a high resolution, a high frame frequency and high sensitivity.

Hereinafter, it will be described what configuration and driving method are preferably adopted for the solid-state image sensor 81 in order to read an image signal with the frame frequency changed according to the sensitivity property. After that, it will be described exactly what processing is performed by the signal processor in order to obtain respective image signals with high resolutions and high frame frequencies based on the multiple image signals thus obtained.

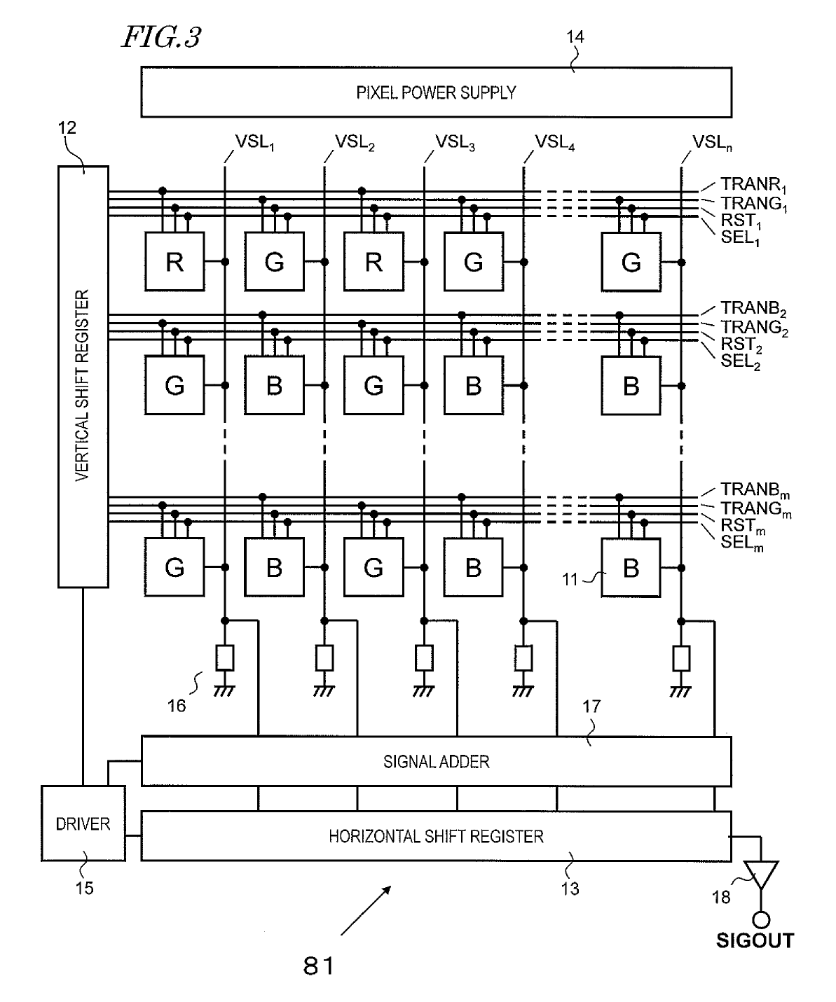

FIG. 3 illustrates a configuration for the solid-state image sensor 81 of this preferred embodiment. A number of pixels 11, which have sensitivities in three wavelength ranges that are respectively associated with the three primary colors of light (i.e., red (R), green (G) and blue (B)), are arranged two-dimensionally to form a matrix pattern and surrounded with a vertical shift register 12 and a horizontal shift register 13 that scan those pixels 11. In this case, the vertical shift register 12 and the horizontal shift register 13 together function as a reading circuit for reading pixel signals from respective pixels of the solid-state image sensor 81. However, a decoder may also be used as a reading circuit.

The solid-state image sensor 81 further includes a pixel power supply 14, a driver 15, a signal adder 17, and an output amplifier 18. The pixel power supply 14 supplies a voltage that needs to be applied to read a pixel signal from any of those pixels. The signal adder 17 adds together the pixel signals of multiple pixels and outputs their sum signal. This is spatial addition processing such as so-called binning processing. The driver 15 controls the respective operations of the vertical shift register 12, the horizontal shift register 13 and the signal adder 17.

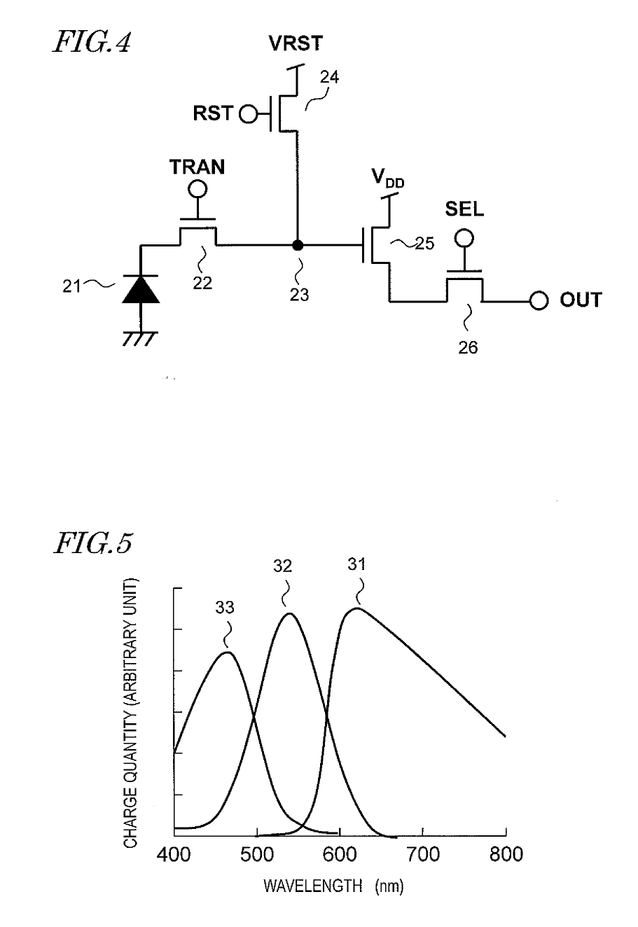

FIG. 4 illustrates a circuit configuration for each of those pixels 11. As shown in FIG. 4, a photodiode 21, which is a photoelectric transducer, includes an R, G or B color filter on its light incident surface and converts an incoming light ray falling within the R, G or B wavelength range into a quantity of charge in proportion to the intensity of the incoming light ray. These photodiodes with the R, G and B color filters will be referred to herein as an “R pixel”, a “G pixel” and a “B pixel”, respectively.

FIG. 5 shows the photoelectric conversion properties 31, 32 and 33 of the R, G and B pixels. The R, G, B pixel spectra 31, 32 and 33 have their peaks around wavelength of 470 nm, 550 nm and 620 nm, respectively. As will be described later, to detect the motion of the subject from the R and B images and generate an interpolated frame for the G image, the color filters to use preferably have G and B spectra that overlap with each other in a wavelength range and also have G and R spectra that overlap with each other in another wavelength range.

To the photodiode 21, connected is the gate of an output transistor 25 by way of a transfer transistor 22. The charge is photoelectrically converted by gate capacitance and a parasitic capacitance at a node 23 and then converted into a signal voltage (i.e., subjected to a Q-V conversion). The output transistor 25 is connected to a select transistor 26, which selects an arbitrary one of those pixels that are arranged in a matrix pattern and provides its pixel signal to an output terminal OUT. And the output terminal OUT is connected to a vertical signal line VSL (of which the subscript indicates its column number in FIG. 3 and) which is grounded at one terminal through a load element 16.

When the select transistor 26 is in ON state, the output transistor 25 and the load element 16 form a source follower circuit. A pixel signal is generated by photoelectrically converting the light that has been incident on a pixel, supplied from the source follower circuit to the horizontal shift register 81 by way of the signal adder 17, transferred horizontally, amplified by the output amplifier 18, and then output serially through the output terminal SIGOUT. To reset the gate potential after a pixel signal has been output, a reset transistor 24 is connected to the node 23. The gate terminal that controls the transfer transistor 22 is connected to a control signal line TRANR, TRANG or TRANB (of which the subscript indicates its row number in FIG. 3 and) which is connected in common to an associated group of pixels of the same color that are arranged in the row direction.

The solid-state image sensor of this preferred embodiment is partly characterized in that the TRAN lines are connected differently than in the conventional solid-state image sensor. Meanwhile, the gate terminals that control the reset transistors 24 of a group of pixels that are arranged in the row direction are connected in common to the same control signal line RST (of which the subscript indicates its row number in FIG. 3). Likewise, the gate terminals that control the select transistors 26 of a group of pixels that are arranged in the row direction are also connected in common to the same control signal line SEL (of which the subscript indicates its row number in FIG. 3). These lines TRANR, TRANG, TRANB, RST and SEL that run in the row direction are activated or inactivated by a control pulse applied by the vertical shift register 12.

The solid-state image sensor 81 reads pixel signals from one pixel after another with the group of lines that run in the row direction activated, performs the same operation a number of times vertically to make a vertical scan, and then makes the horizontal shift register 13 transfer the pixel signal horizontally, thereby outputting two-dimensional image information serially. When shooting a subject with high illuminance in a bright shooting environment, the solid-state image sensor 81 also reads pixel signals from all pixels by activating TRANR, TRANG and TRANB on a frame-by-frame basis as in the conventional solid-state image sensor.

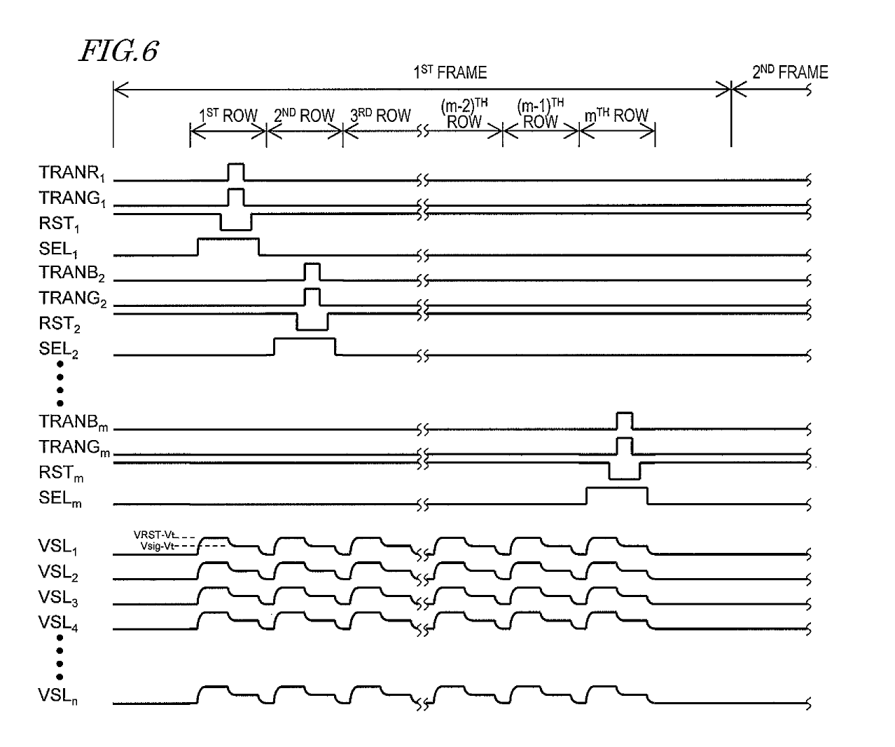

FIG. 6 shows the drive timings of pulses to be applied from the vertical shift register 11 to TRANR, TRANG, TRANB, RST and SEL lines during one frame period of a read operation and also shows how potentials on vertical signal lines L vary during that period. To an inactive row, a low potential is applied to the TRANR, TRANG and TRANB lines, a high potential is applied to the RST line, and a low potential is applied to the SEL line.

As for a row to be activated to read a pixel signal from, on the other hand, first of all, a high potential is applied to the SEL line to turn the select transistor 26 ON and connect the pixel 11 to its associated vertical signal line VSL. Since the RST line has the high potential at this time, the reset transistor 24 has been turned ON. And as a voltage VRST is applied to the gate of the output transistor 25, the potential on the VSL changes into a high-level reset voltage VRST−Vt (where Vt is the threshold voltage of the output transistor).

Next, the potential on the RST line is changed into the low potential to turn the reset transistor 24 OFF. And a high potential is applied to either the TRANR and TRANG lines or the TRANG and TRANB lines (the combination of the colors changes from one row to another), thereby turning the transfer transistor 22 ON. As a result of this operation, the charge that has been photoelectrically converted by the photodiode 21 moves to the gate of the output transistor 25, where the charge is subjected to the Q-V conversion to decrease the gate potential to Vsig. At the same time, the voltage level on the VSL also decreases to a signal voltage Vsig−Vt.

In this case, correlated double sampling (which is made by calculating the difference between the reset voltage VRST−Vt that has been output to the VSL and the signal voltage Vsig−Vt) is preferably carried out by a differential circuit that is arranged inside or outside of the sensor. This is because by calculating the difference, the term Vt can be removed from the output voltage VRST−Vsig and deterioration in image quality due to a variation in Vt can be reduced.

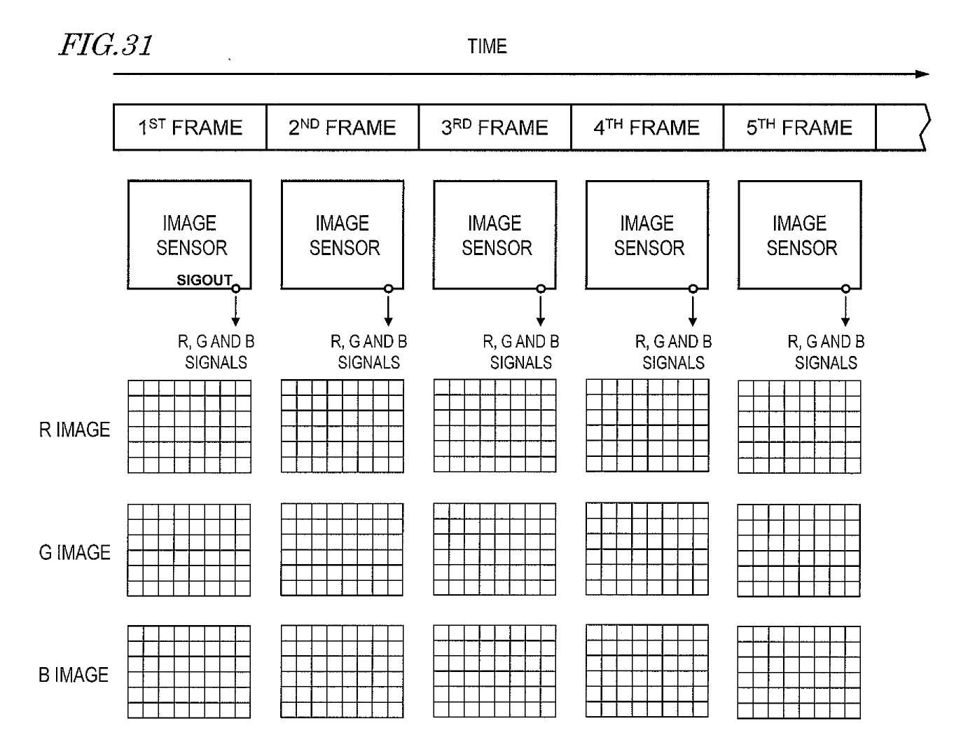

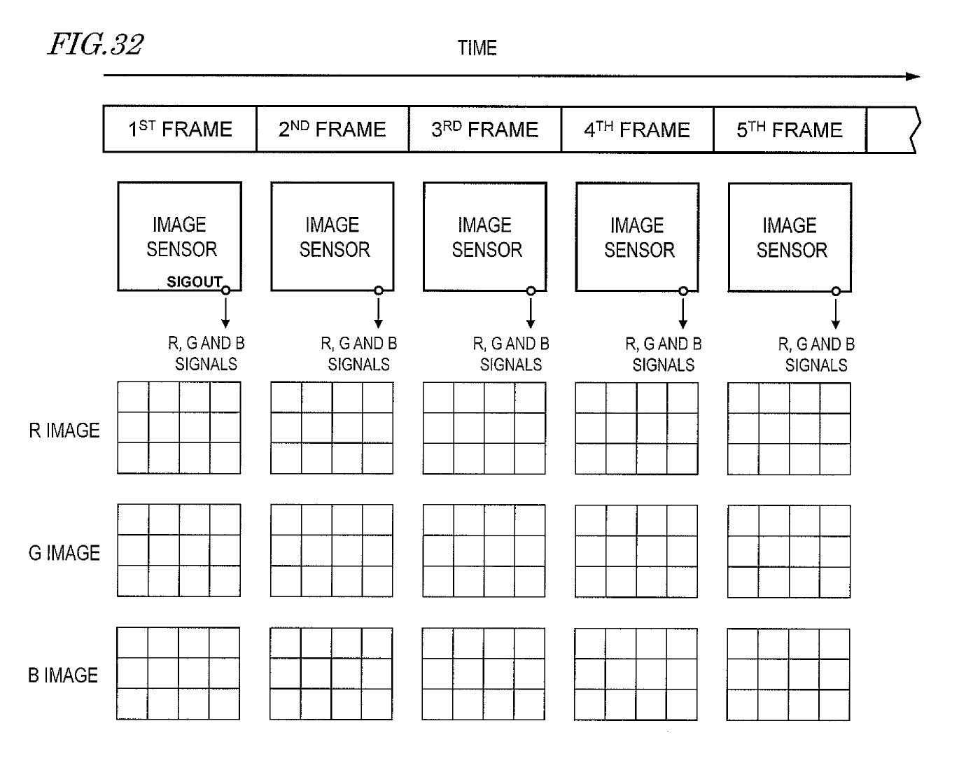

After the signal voltage has been output to VSL, the potentials on the TRANR and TRANG lines or the TRANG and TRANB lines are decreased to the low potential, the potential on the RST line is increased to the high potential, and the potential on the SEL line is decreased to the low potential in this order, thereby finishing the read operation. By sequentially performing this operation in the row direction, a moving picture, each frame of which consists of all pixel signals as shown in FIG. 31, for example, can be shot.

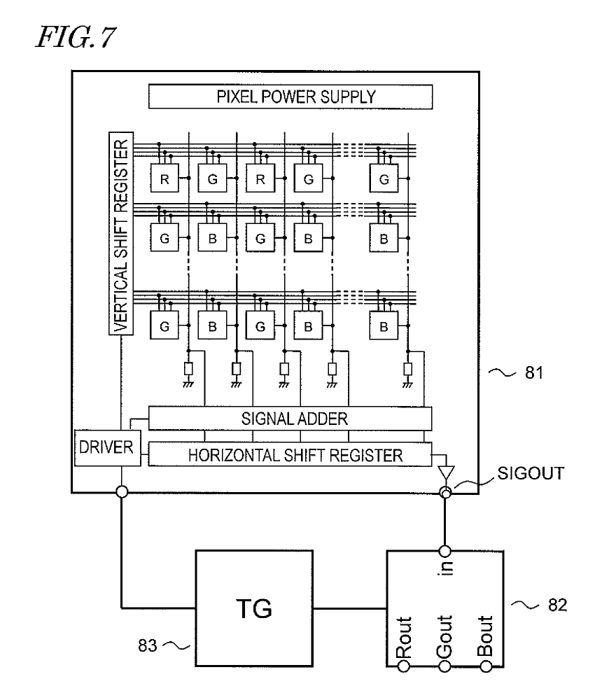

On the other hand, if a low-illuminance subject is going to be shot in a dark shooting environment, then the differential output voltage (VRST−Vsig) on the VSL decreases. FIG. 7 illustrates a configuration for a camera system in which a signal processor 82 and a timing generator (TG) 83 are connected to the output terminal SIGOUT of the solid-state image sensor 81.

The signal processor 82 senses a decrease in the luminance level of the image and issues an instruction to change the modes of shooting into a high-sensitivity shooting mode to the timing generator 83. On finding the luminance equal to or lower than a reference level, the signal processor 82 senses that the luminance level of the subject image has decreased. Such a condition in which the luminance has become equal to or lower than the reference level will be referred to herein as a “dark shooting environment”. On the other hand, a condition in which the luminance has not decreased to the reference level or less yet will be referred to herein as a “bright shooting environment”.

On receiving the instruction to change the modes of shooting, the timing generator 83 changes the frequency of applying a timing pulse to the driver 15 that controls the vertical and horizontal shift registers 12 and 13 that are built in the solid-state image sensor 81. As a result, the vertical and horizontal shift registers 12 and 13 have their operating frequencies changed when reading an image. In this case, TRANR and TRANB are activated every frame and TRANG is activated every four frames. That is to say, in the (4n−3)^{th} frame (where n is a natural number), TRANR, TRANG and TRANB are activated and then signals from all pixels are output to the VSL as shown in FIG. 6.

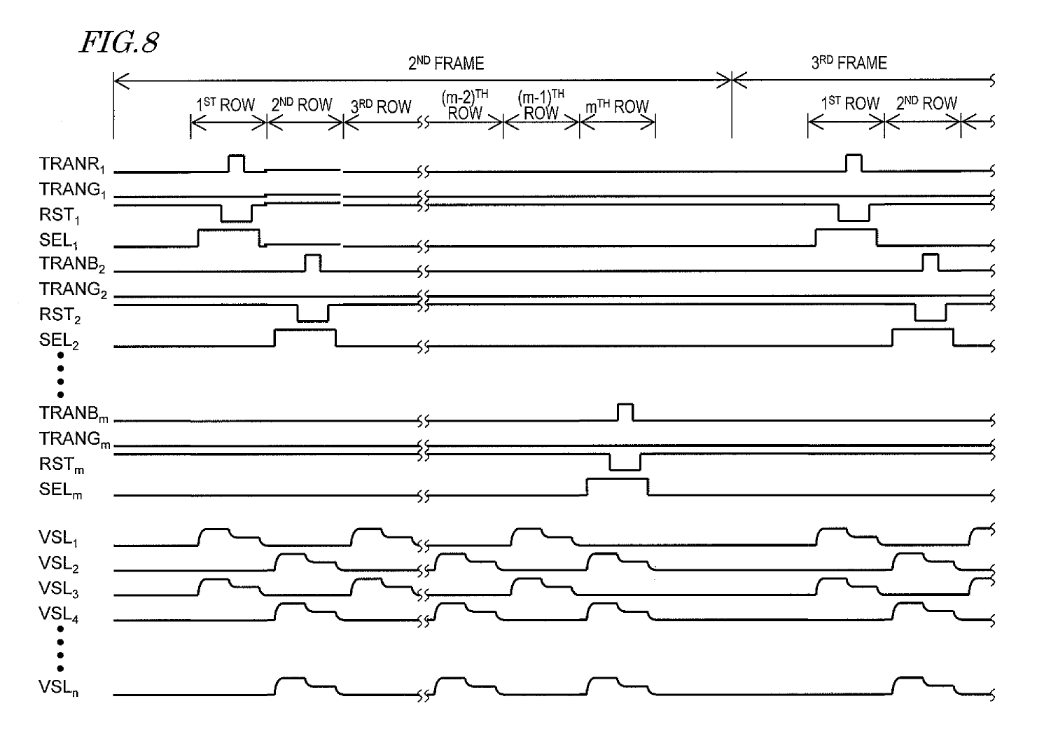

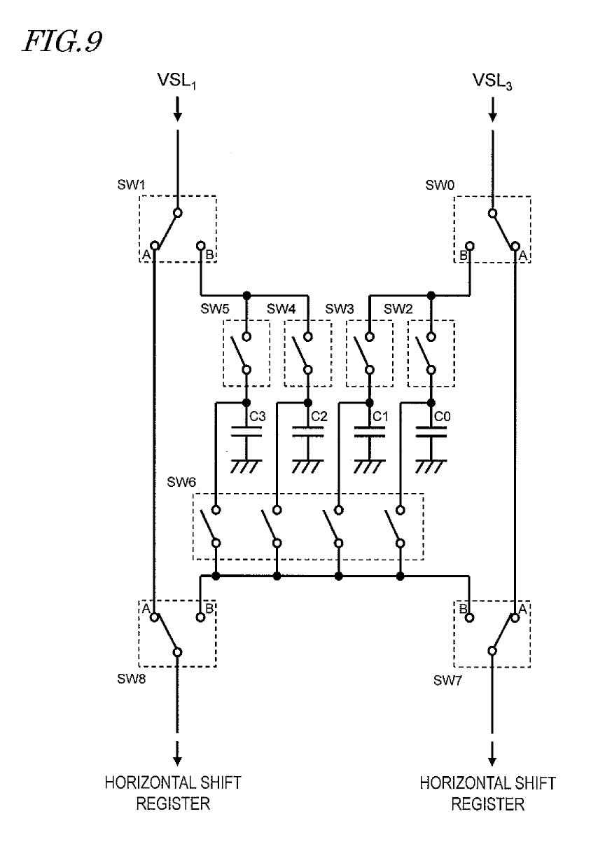

In the (4n−2)^{th}, (4n−1)^{th} and 4n^{th} frames that follow the (4n−3)^{th} frame, only the TRANR and TRANB lines are activated. FIG. 8 shows the drive timings of pulses to be applied in such a situation where only the TRANR and TRANB lines are activated in the (4n−2)^{th}, (4n−1)^{th} and 4n^{th} frames. Specifically, in the (4n−2)^{th}, (4n−1)^{th} and 4n^{th} frames, when a read operation is performed on an odd row, signal voltages from the R pixels are output to only the VSLs associated with odd columns. On the other hand, when a read operation is performed on an even row, signal voltages from the B pixels are output to only the VSLs associated with even columns.

Furthermore, in the high-sensitivity shooting mode, the signal adder 17 gets activated by the driver 15 so as to add four R pixels and four B pixels together. The signal adder 17 adds four pixel signals together and then outputs their average as a signal voltage. The noise component included in the pixel signal can be decreased to a voltage value that has been divided by the root of the number of signals to add together, and therefore, can be halved (=1/(4^{1/2})). That is to say, the S/N ratio (SNR) can be doubled.

FIG. 9 illustrates a configuration for a portion of the signal adder 17 that is used to process two columns of pixels. Hereinafter, it will be described, as an example, how to add together pixel signals that have been output from R pixels at the intersections between the first and third rows and the first and third columns. Before entering the high-sensitivity shooting mode, switches SW0, SW1, SW7 and SW8 are turned to the contact A side by the driver 15 and the signal voltage applied to the signal adder 17 is output as it is to the horizontal shift register 13.

When a read operation is performed on the first row, the switches SW0, SW1, SW7 and SW8 are turned to the contact B side and switches SW2 and SW4 are turned ON in accordance with the instruction given by the driver 15. In such a state, TRANR₁ is activated and the signal voltages Vsig₁₁−Vt and Vsig₁₃−Vt that have been output from R pixels to VS1₁ and VSL₃ are written on capacitors C0 and C2, respectively. Meanwhile, the switches SW0, SW1, SW7 and SW8 of the signal adder 17 that are connected to even columns are turned to the contact A side and the signal voltages that are supplied from G pixels only in the (4n−3)^{th} frame are output as they are to the horizontal shift register 13.

Next, the switches SW2 and SW4 are turned OFF and the switches SW0, SW1, SW7 and SW8 are turned to the contact A side to perform a read operation on the second row. If it is the (4n−3)^{th} frame, the signal voltages that are supplied from G pixels are output as they are to the horizontal shift register 13. But in the other frames, no input signals are supplied from the G pixels. No matter which of the (4n−3)^{th}, (4n−2)^{th}, (4n−1)^{th} and 4n^{th} frames it is, the signal adder 17 connected to the even columns writes the signal voltages supplied from the B pixels onto the capacitors.

Next, when a read operation is performed on the third row, the switches SW0, SW1, SW7 and SW8 are turned to the contact B side and switches SW3 and SW5 are turned ON. In such a state, TRANR₃ is activated and the signal voltages Vsig₃₁−Vt and Vsig₃₃−Vt that have been output from R pixels to VSL₁ and VSL₃ are written on capacitors C1 and C3, respectively. Subsequently, the switches SW3 and SW5 are turned OFF and the switch SW6 is turned ON. As a result of this operation, the signal voltages that have been written on the four capacitors C0 through C3 are added together and the sum of the signal voltages (Vsig₁₁+Vsig₁₃+Vsig₃₁+Vsig₃₃)/4−Vt is output to the horizontal shift register 13. Meanwhile, the switches SW0, SW1, SW7 and SW8 of the signal adder 17 that are connected to even columns are turned to the contact A side and the signal voltages that are supplied from G pixels only in the (4n−3)^{th} frame are output as they are to the horizontal shift register 13.

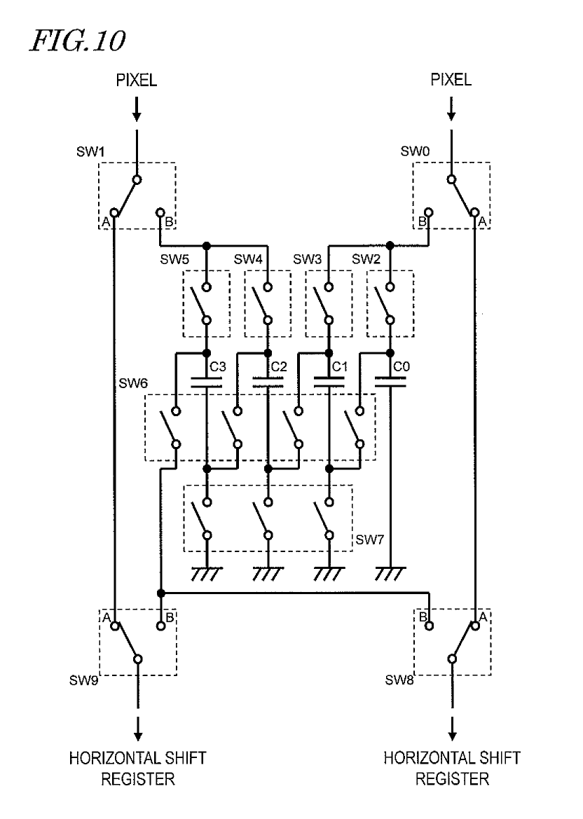

Optionally, the signal adder 17 shown in FIG. 9 may be replaced with the signal adder shown in FIG. 10. In that case, not just can the S/N ratio (SNR) be increased as significantly as that signal adder but also can the signal output level be increased as well. As a result, the output signal can have higher resistance to incoming noise. FIG. 10 illustrates a configuration for a portion of the signal adder that is used to process two columns of pixels. Hereinafter, it will be described, as an example, how to add together pixel signals that have been output from R pixels at the intersections between the first and third rows and the first and third columns.

When a read operation is performed on the first row, switches SW0, SW1, SW8 and SW9 are turned to the contact B side, a switch SW6 is turned OFF, a switch SW7 is turned ON, and switches SW2 and SW4 are turned ON in accordance with the instruction given by the driver 15. In such a state, TRANR₁ is activated and the signal voltages Vsig₁₁−Vt and Vsig₁₃−Vt that have been output from R pixels to VSL₁ and VSL₃ are written on capacitors C0 and C2, respectively. Meanwhile, the switches SW0, SW1, SW8 and SW9 of the signal adder 17 that are connected to even columns are turned to the contact A side and the signal voltages that are supplied from G pixels only in the (4n−3)^{th} frame are output as they are to the horizontal shift register 13.

Next, the switches SW2 and SW4 are turned OFF and the switches SW0, SW1, SW8 and SW9 are turned to the contact A side to perform a read operation on the second row. If it is the (4n−3)^{th} frame, the signal voltages that are supplied from G pixels are output as they are to the horizontal shift register 13. But in the other frames, no input signals are supplied from the G pixels. No matter which of the (4n—3)^{th}, (4n−2)^{th}, (4n−1)^{th} and 4n^{th} frames it is, the signal adder 17 connected to the even columns writes the signal voltages supplied from the B pixels onto the capacitors.

Next, when a read operation is performed on the third row, the switches SW0, SW1, SW8 and SW9 are turned to the contact B side and switches SW3 and SW5 are turned ON. In such a state, TRANR₃ is activated and the signal voltages Vsig₃₁−Vt and Vsig₃₃−Vt that have been output from R pixels to VSL₁ and VSL₃ are written on capacitors C1 and C3, respectively. Subsequently, the switches SW3 and SW5 are turned OFF, the switch SW7 is also turned OFF, and the switch SW6 is turned ON. As a result of this operation, the signal voltages that have been written on the four capacitors C0 through C3 are added together and the sum of the signal voltages (Vsig₁₁+Vsig₁₃+Vsig₃₁+Vsig₃₃)−4Vt is output to the horizontal shift register 13. Meanwhile, the switches SW0, SW1, SW7 and SW8 of the signal adder 17 that are connected to even columns are turned to the contact A side and the signal voltages that are supplied from G pixels only in the (4n−3)^{th} frame are output as they are to the horizontal shift register 13.

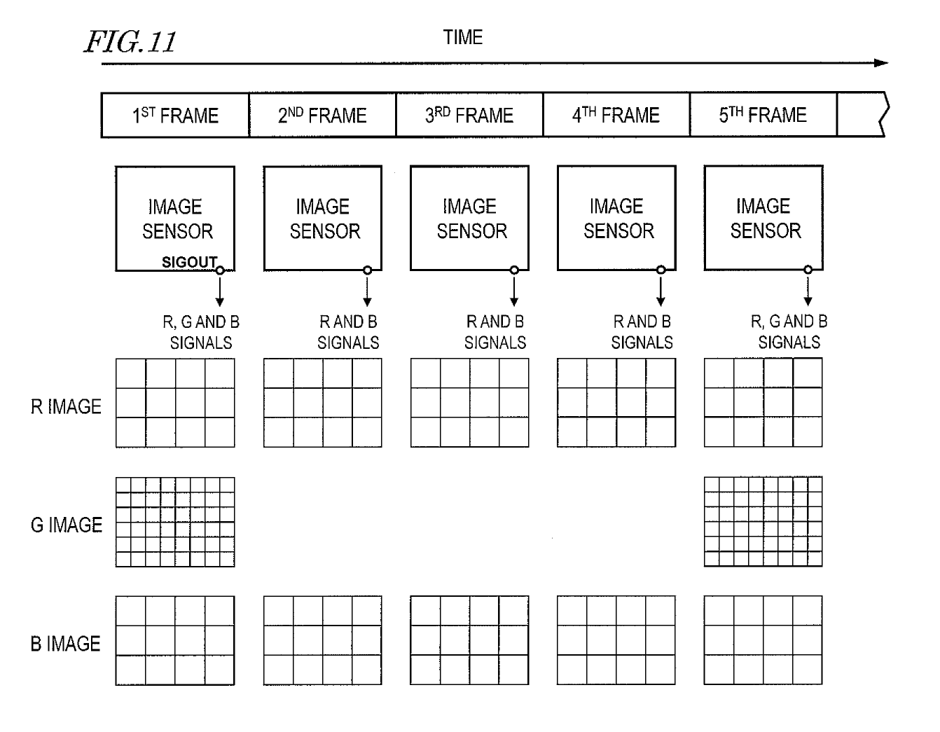

FIG. 11 illustrates respective image frames that have been output from the image sensor (i.e., the solid-state image sensor 81). According to the processing described above, G images with a full resolution are output every four frames, and R and B images with a half vertical resolution and a half horizontal resolution are output every frame.

Since the exposure time of a G pixel is four times as long as that of R and B pixels, even a low-illuminance subject in a dark environment can be shot with high sensitivity. On the other hand, since the R and B pixels have had their signal levels increased fourfold by adding together the signals of four pixels, the subject can also be shot with high sensitivity even in a dark environment. This virtually means that each photodiode, which performs the photoelectric conversion, has had its photosensitive area increased fourfold.

The signal processor 82 detects the motion of the subject based on the R and B images that have been supplied at high frame frequencies and generates an interpolated frame for the G image, thereby increasing the frame frequency of the G image. At the same time, the signal processor 82 also generates interpolated pixels for the R and B images based on the G image that has been supplied with the full resolution, thereby increasing the resolutions of the R and B images.

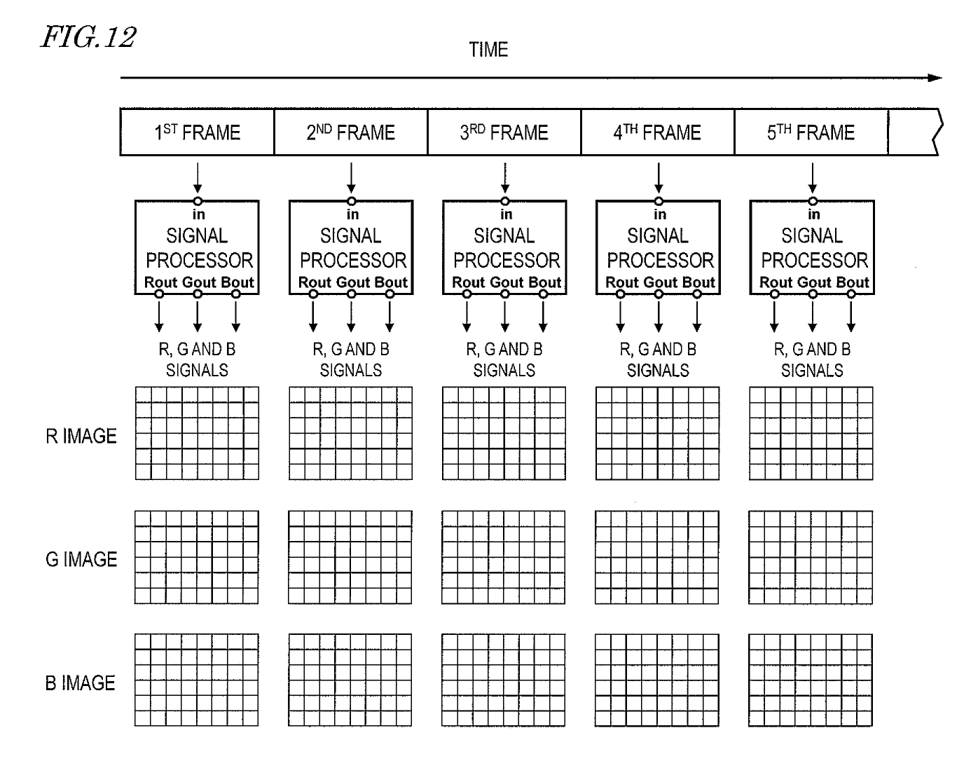

FIG. 12 illustrates R, G and B images to be output from the signal processor 82 with the full resolution and at high frame frequencies. By synthesizing the respective images together, a color moving picture can be obtained.

Hereinafter, processing for obtaining a moving picture, of which the R, G and B images all have the full resolution and high frame frequencies, will be described in detail.

FIG. 13 is a block diagram illustrating a configuration for a camera system 100 according to this preferred embodiment. In FIG. 13, the camera system 100 includes a lens 151, a solid-state image sensor 81 and a signal processor 82.

The configuration of the solid-state image sensor 81 is just as already described.

The solid-state image sensor 81 temporally adds together the pixel values of photoelectrically converted G pixels for a number of frames. As used herein, to “temporally add together” means adding together the pixel values of respective pixels that have the same pixel coordinates in common in all of a series of frames (or pictures). According to the present invention, such temporal addition of the pixel values is done by performing an exposure process for a long time with the frame frequency decreased in the high sensitivity shooting mode. More specifically, as already described about its operation, G pixels are read every four frames, thereby performing each exposure process for four frame periods, which is equivalent to temporally adding together the pixel values of the four frames. The temporal addition is preferably carried out by adding together the respective pixel values of pixels that have the same pixel coordinates within the range of two to nine frames.

The solid-state image sensor 81 also spatially adds together not only the respective pixel values of the photoelectrically converted R images but also those of the B images as well. As used herein, to “spatially add together” means adding together the respective pixel values of multiple pixels that form one frame (or one picture) that has been shot at a point in time. According to the present invention, such spatial addition of the pixel values is done by performing binning processing with the signal adder activated in the high sensitivity shooting mode. Specifically, according to the operation described above, R and B pixels are read every frame, the values of four pixels, consisting of two horizontal pixels multiplied by two vertical pixels, are added together, and then the sum is output. Examples of “multiple pixels” include two horizontal pixels×one vertical pixel, one horizontal pixel×two vertical pixels, two horizontal pixels×two vertical pixels, two horizontal pixels×three vertical pixels, three horizontal pixels×two vertical pixels and three horizontal pixels×three vertical pixels. The pixel values (i.e., the photoelectrically converted values) of these multiple pixels are added together spatially.

The signal processor 82 receives the data of the G image that has been subjected to the temporal addition by the solid-state image sensor 81 and the data of the R and B images that have been subjected to the spatial addition by the solid-state image sensor 81, and makes an image restoration on those data, thereby estimating the R, G and B values of the respective pixels and restoring a color image.

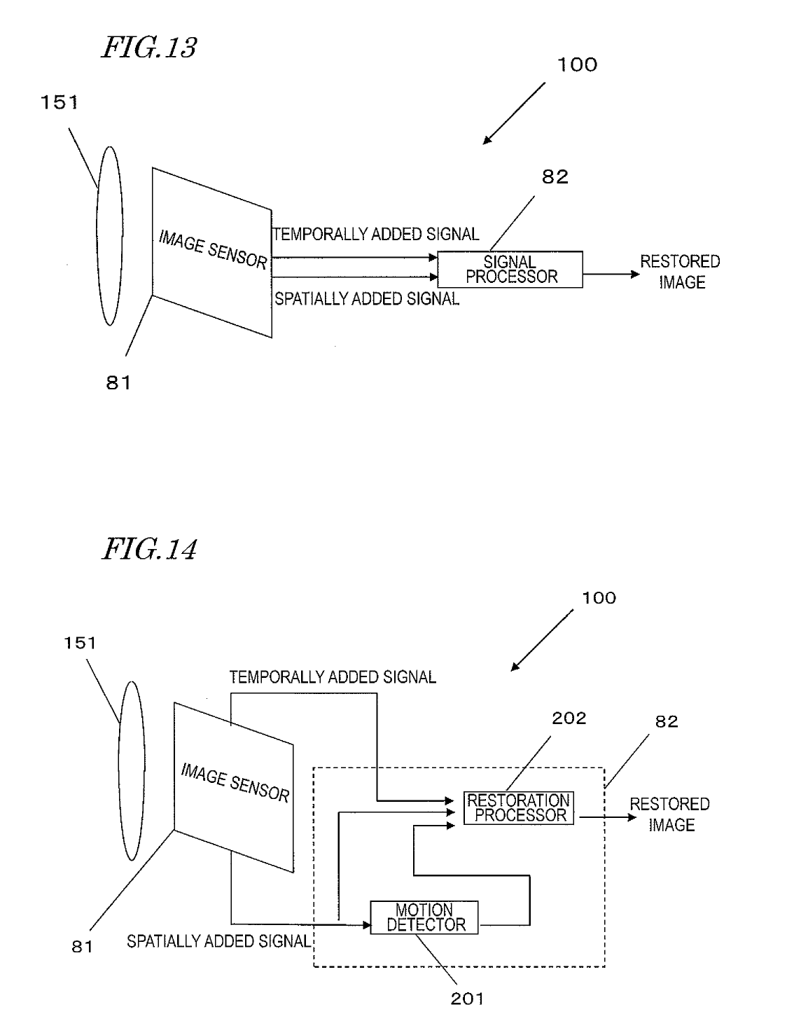

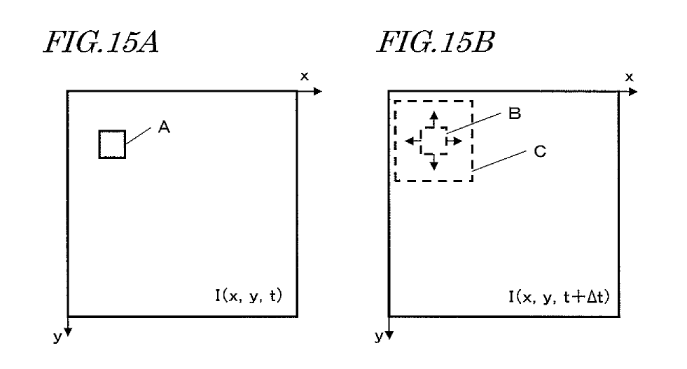

FIG. 14 illustrates a more detailed configuration for the signal processor 82. In FIG. 14, every component but the signal processor 82 is the same as its counterpart shown in FIG. 13. The signal processor 82 includes a motion detector 201 and a restoration processor 202. The functions of the motion detector 201 and the restoration processor 202 to be described below may be performed as parts of the processing carried out by the signal processor 82.

The motion detector 201 detects a motion (as an optical flow) from the data of the spatially added R and B images by using known techniques such as block matching, gradient method, and phase correlation method. Then, the motion detector 201 outputs the motion information thus detected. The known techniques are disclosed by P. Anandan in “A Computational Framework and an Algorithm for the Measurement of Visual Motion”, International Journal of Computer Vision, Vol. 2, pp. 283-310, 1989, for example.

FIGS. 15A and 15B respectively illustrate a base frame and a reference frame for use to detect a motion by block matching. Specifically, the motion detector 201 sets a window area A shown in FIG. 5A in the base frame (i.e., a picture in question at a time t, from which the motion needs to be detected), and then searches the reference frame for a pattern that is similar to the pattern inside the window area. As the reference frame, the frame that follows the base frame is often used.

The search range is usually defined to be a predetermined range (which is identified by C in FIG. 158) with respect to a point B, at which the magnitude of motion is zero. Also, the degree of similarity between the patterns is estimated by calculating, as an estimate, either the sum of squared differences (SSD) represented by the following Equation (1) or the sum of absolute differences (SAD) represented by the following Equation (2):

$$\begin{matrix}S S D = {\sum }_{x , y ∈ W} {( f ( x + u , y + v , t + Δ t ) - f ( x , y , t ) )}^{2} & ( 1 ) \\ S A D = {\sum }_{x , y ∈ W} \vert f ( x + u , y + v , t + Δ t ) - f ( x , y , t ) \vert & ( 2 )\end{matrix}$$

In Equations (1) and (2), f (x, y, t) represents the temporal or spatial distribution of images (i.e., pixel values) and x, y ∈ means the coordinates of pixels that fall within the window area in the base frame.

The motion detector 201 changes (u, v) within the search range, thereby searching for a set of (u, v) coordinates that minimizes the estimate value and defining the (u, v) coordinates to be a motion vector between the frames. And by sequentially shifting the positions of the window areas set, the motion is detected either on a pixel-by-pixel basis or on the basis of a block (which may consist of 8 pixels×8 pixels, for example).

According to the present invention, the motion detection is carried out on spatially added images in two out of the three colors of a single-panel color image to which a color filter array is attached, and therefore, attention needs to be paid to the step of variation of (u, v) within the search range.

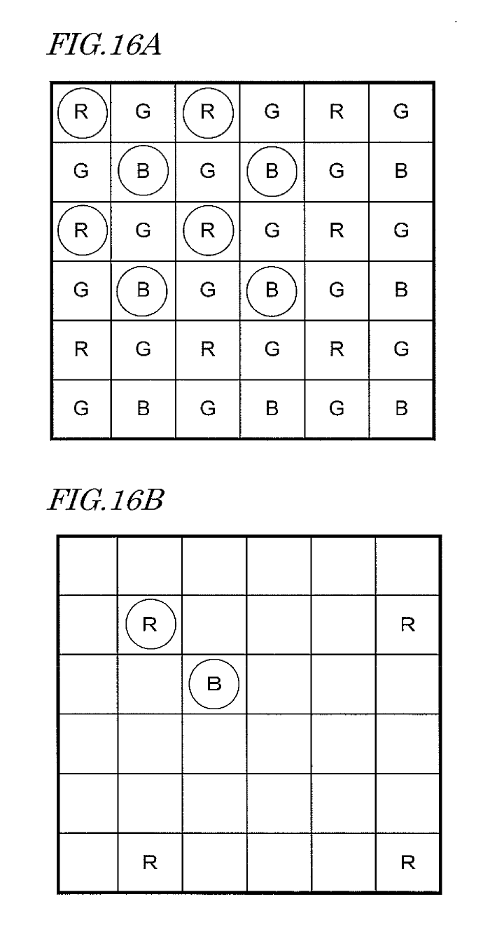

FIGS. 16A and 16B show virtual sample points in a situation where spatial addition is performed on 2×2 pixels. In FIGS. 16A and 16B, R, G and B mean pixels to which red, green and blue color filters are respectively attached. It should be noted, however, that in the following description, when we say just R, G or B, it may refer to an image consisting of only components in that color.

Specifically, FIG. 16B illustrates virtual sample points that are obtained by subjecting R and B shown in FIG. 16A to 2×2 pixel spatial addition. In that case, the virtual sample points are arranged at regular intervals (i.e., every four pixels) for only either R or B, but all sample points including both R and B are arranged irregularly. That is why the (u, v) coordinates represented by either Equation (1) or (2) need to be changed every four pixels in this case. Alternatively, the R and B values of respective pixels may be obtained based on the R and B values of virtual sample points shown in FIG. 16B by a known interpolation method and then the (u, v) coordinates may be changed every other pixel.

By applying a linear function or a quadratic function to the distribution of (u, v) coordinates in the vicinity of the (u, v) coordinates thus obtained that minimize either Equation (1) or (2) (which is a known technique called “conformal fitting” or “parabolic fitting”), motion detection is carried out on a subpixel basis.

<How to Restore the G Pixel Value of Each Pixel>

The restoration processor 202 calculates the G pixel value of each pixel by minimizing the following Expression (3):

|Hf−g|^{M}+Q (3)

In Equation (3), H represents the sampling process, f represents a G image to be restored with a high spatial resolution and a high temporal resolution, g represents a G image that has been captured by the solid-state image sensor 81, M represents the exponent, and Q represents the condition to be satisfied by the image f to be restored, i.e., a constraint.

f and g are column vectors, each of which consists of the respective pixel values of a moving picture. In the following description, a vector representation of an image means a column vector in which pixel values are arranged in the order of raster scan. On the other hand, a function representation means the temporal or spatial distribution of pixel values. If a pixel value is a luminance value, one pixel may have one pixel value. Supposing the moving picture to restore consists of 2,000 horizontal pixels by 1,000 vertical pixels in 30 frames, for example, the number of elements of f becomes 60,000,000 (=2,000×1,000×30).

If an image is captured by an image sensor with a Bayer arrangement such as the one shown in FIGS. 16A and 16B, the number of elements of g becomes 30,000,000, which is a half as large as that of f. The vertical and horizontal numbers of pixels of f and the number of frames for use to carry out signal processing are set by the signal processor 82. In the sampling process H, f is sampled. H is a matrix, of which the number of rows is equal to the number of elements of g and the number of columns is equal to the number of elements of f.

As computers used extensively today have too much amount of information about the number of pixels of a moving picture (which may consist of 200 horizontal pixels×1,000 vertical pixels) and the number of frames (which may be 30 frames, for example), f that minimizes Equation (2) cannot be obtained through a single series of processing. In that case, by repeatedly performing the processing of obtaining f on temporal and spatial partial regions, the moving picture f to restore can be calculated.

Hereinafter, it will be described by way of a simple example how to formulate the sampling process H. Specifically, it will be described how to capture G in a situation where an image consisting of two horizontal pixels (where x=1, 2) by two vertical pixels (where y=1, 2) in two frames (where t=1, 2) is captured by an image sensor with a Bayer arrangement and G is added for two frame periods.

$$\begin{matrix}f = {( \begin{matrix}{G}_{111} & {G}_{211} & {G}_{121} & {G}_{221} & {G}_{112} & {G}_{212} & {G}_{122} & {G}_{222}\end{matrix} )}^{T} & ( 4 ) \\ H = ( \begin{matrix}0 & 1 & 0 & 0 & 0 & 1 & 0 & 0 \\ 0 & 0 & 1 & 0 & 0 & 0 & 1 & 0\end{matrix} ) & ( 5 )\end{matrix}$$

In this case, the sampling process H may be formulated as follows:

$$\begin{matrix}g = Hf \\ = ( \begin{matrix}0 & 1 & 0 & 0 & 0 & 1 & 0 & 0 \\ 0 & 0 & 1 & 0 & 0 & 0 & 1 & 0\end{matrix} ) \\ = {( \begin{matrix}{G}_{111} & {G}_{211} & {G}_{121} & {G}_{221} & {G}_{112} & {G}_{212} & {G}_{122} & {G}_{222}\end{matrix} )}^{T} \\ = {( \begin{matrix}{G}_{211} + {G}_{212} & {G}_{121} + {G}_{122}\end{matrix} )}^{T}\end{matrix} \qquad ( 6 )$$

In Equation (4), G₁₁₁ through G₂₂₂ represent the G values of respective pixels and each of these three-digit subscripts indicates the x, y and z values in this order. Since g is an image that has been captured by an image sensor with the Bayer arrangement, its number of pixels is a half as large as that of an image, of which every pixel has been read.

The value of the exponent M in Equation (3) is not particularly limited but is preferably one or two from the standpoint of computational complexity.

Equation (6) represents the process of obtaining g by capturing f with an image sensor with a Bayer arrangement. Conversely, the problem of restoring f from g is generally called a “reverse problem”. If there are no constraints Q, there is an infinite number of f that minimizes the following Expression (7):

|Hf−g|^{M} (7)

This can be explained easily because this Expression (7) is satisfied even if an arbitrary value is substituted for a pixel value not to be sampled. That is why f cannot be solved uniquely just by minimizing Expression (7).

Thus, to obtain a unique solution with respect to f, a smoothness constraint on the distribution of the pixel values f or a smoothness constraint on the distribution of image motions derived from f is given as Q.

The smoothness constraint on the distribution of the pixel values f may be given by any of the following constraint equations (8) and (9):

$$\begin{matrix}Q = {\vert \frac{\partial f}{\partial x} \vert}^{m} + {\vert \frac{\partial f}{\partial y} \vert}^{m} & ( 8 ) \\ Q = {\vert \frac{{\partial }^{2} f}{\partial {x}^{2}} \vert}^{m} + {\vert \frac{{\partial }^{2} f}{\partial {y}^{2}} \vert}^{m} & ( 9 )\end{matrix}$$

where ∂f/∂x is a column vector that consists of first-order x-direction differential values of the pixel values of a moving picture to be restored, ∂f/∂y is a column vector that consists of first-order y-direction differential values of the pixel values of a moving picture to be restored, ∂²f/∂²x is a column vector that consists of second-order x-direction differential values of the pixel values of a moving picture to be restored, ∂²f/∂²y is a column vector that consists of second-order y-direction differential values of the pixel values of a moving picture to be restored, and | | indicates the norm of each of these vectors. Just like the exponent M in Equation (2) and Expression (7), the value of the exponent m is preferably one or two.

Optionally, these partially differentiated values ∂f/∂x, ∂f/∂y, ∂²f/∂²x and ∂²f/∂²y may be approximated by the following Equation (10), for example, by expanding the differences with the values of pixels surrounding the pixel in question:

$$\frac{\partial f ( x , y , t )}{\partial x} = \frac{f ( x + 1 , y , t ) - f ( x - 1 , y , t )}{2} \\ \frac{\partial f ( x , y , t )}{\partial y} = \frac{f ( x , y + 1 , t ) - f ( x , y - 1 , t )}{2} \\ \frac{{\partial }^{2} f ( x , y , t )}{\partial {x}^{2}} = f ( x + 1 , y , t ) - 2 f ( x , y , t ) + f ( x - 1 , y , t ) \\ \frac{{\partial }^{2} f ( x , y , t )}{\partial {y}^{2}} = f ( x , y + 1 , t ) - 2 f ( x , y , t ) + f ( x , y - 1 , t ) \qquad ( 10 )$$

To expand the differences, this Equation (10) does not always have to be used but other surrounding pixels may also be used as reference pixels as in the following Equation (11):

$$\frac{\partial f ( x , y , t )}{\partial x} = \frac{1}{6} ( f ( x + 1 , y - 1 , t ) - f ( x - 1 , y - 1 , t ) + f ( x + 1 , y , t ) - f ( x - 1 , y , t ) + f ( x + 1 , y + 1 , t ) - f ( x - 1 , y + 1 , t ) ) \\ \frac{\partial f ( x , y , t )}{\partial y} = \frac{1}{6} ( f ( x - 1 , y + 1 , t ) - f ( x - 1 , y - 1 , t ) + f ( x , y + 1 , t ) - f ( x , y - 1 , t ) + f ( x + 1 , y + 1 , t ) - f ( x + 1 , y - 1 , t ) ) \\ \frac{{\partial }^{2} f ( x , y , t )}{\partial {x}^{2}} = \frac{1}{3} ( f ( x + 1 , y - 1 , t ) - 2 f ( x , y - 1 , t ) + f ( x - 1 , y - 1 , t ) + f ( x + 1 , y , t ) - 2 f ( x , y , t ) + f ( x - 1 , y , t ) + f ( x + 1 , y + 1 , t ) - 2 f ( x , y + 1 , t ) + f ( x - 1 , y + 1 , t ) ) \\ \frac{{\partial }^{2} f ( x , y , t )}{\partial {y}^{2}} = \frac{1}{3} ( f ( x - 1 , y + 1 , t ) - 2 f ( x - 1 , y , t ) + f ( x - 1 , y - 1 , t ) + f ( x , y + 1 , t ) - 2 f ( x , y , t ) + f ( x , y - 1 , t ) + f ( x + 1 , y + 1 , t ) - 2 f ( x + 1 , y , t ) + f ( x + 1 , y - 1 , t ) ) \qquad ( 11 )$$

According to this Equation (11), neighboring one of the values calculated by Equation (10) are averaged. As a result, the spatial resolution does decrease but the influence of noise can be reduced. As an intermediate one between these two methods, the following Equation (12) in which α falling within the range 0≦α≦1 is added as a weight may also be used:

$$\frac{\partial f ( x , y , t )}{\partial x} = \frac{1 - α}{2} \frac{f ( x + 1 , y - 1 , t ) - f ( x - 1 , y - 1 , t )}{2} + α \frac{f ( x + 1 , y , t ) - f ( x - 1 , y , t )}{2} + \frac{1 - α}{2} \frac{f ( x + 1 , y + 1 , t ) - f ( x - 1 , y + 1 , t )}{2} \\ \frac{\partial f ( x , y , t )}{\partial y} = \frac{1 - α}{2} f ( x - 1 , y + 1 , t ) - f ( x - 1 , y - 1 , t ) + α \frac{f ( x , y + 1 , t ) - f ( x , y - 1 , t )}{2} + \frac{1 - α}{2} \frac{f ( x + 1 , y + 1 , t ) - f ( x + 1 , y - 1 , t )}{2} \\ \frac{{\partial }^{2} f ( x , y , t )}{\partial {x}^{2}} = \frac{1 - α}{2} ( f ( x + 1 , y - 1 , t ) - 2 f ( x , y - 1 , t ) + f ( x - 1 , y - 1 , t ) ) + α ( f ( x + 1 , y , t ) - 2 f ( x , y , t ) + f ( x - 1 , y , t ) ) + \frac{1 - α}{2} ( f ( x + 1 , y + 1 , t ) - 2 f ( x , y + 1 , t ) + f ( x - 1 , y + 1 , t ) ) \\ \frac{{\partial }^{2} f ( x , y , t )}{\partial {y}^{2}} = \frac{1 - α}{2} ( f ( x - 1 , y + 1 , t ) - 2 f ( x - 1 , y , t ) + f ( x - 1 , y - 1 , t ) ) + α ( f ( x , y + 1 , t ) - 2 f ( x , y , t ) + f ( x , y - 1 , t ) ) + \frac{1 - α}{2} ( f ( x + 1 , y + 1 , t ) - 2 f ( x + 1 , y , t ) + f ( x + 1 , y - 1 , t ) ) \qquad ( 12 )$$

As to how to expand the differences, α may be determined in advance according to the noise level so that the image quality will be improved as much as possible through the processing. Or to cut down the circuit scale or computational complexity as much as possible, Equation (10) may be used as well.

It should be noted that the smoothness constraint on the distribution of the pixel values of the image f does not always have to be calculated by Equation (8) or (9) but may also be the m^{th} power of the absolute value of the second-order directional differential value given by the following Equation (13):

$$\begin{matrix}Q = {\vert \frac{\partial }{\partial {n}_{min}} ( \frac{\partial f}{\partial {n}_{min}} ) \vert}^{m} \\ = {\vert \frac{\partial }{\partial {n}_{min}} ( - sin θ \frac{\partial f}{\partial x} + cos θ \frac{\partial f}{\partial y} ) \vert}^{m} \\ = {\vert - sin θ \frac{\partial }{\partial x} ( - sin θ \frac{\partial f}{\partial x} + cos θ \frac{\partial f}{\partial y} ) + cos θ \frac{\partial }{\partial y} ( - sin θ \frac{\partial f}{\partial x} + cos θ \frac{\partial f}{\partial y} ) \vert}^{m} \\ = {\vert {sin}^{2} θ \frac{{\partial }^{2} f}{\partial {x}^{2}} - sin θ cos θ \frac{{\partial }^{2} f}{\partial x \partial y} - sin θ cos θ \frac{{\partial }^{2} f}{\partial y \partial x} + {cos}^{2} \frac{{\partial }^{2} f}{\partial {y}^{2}} \vert}^{m}\end{matrix} \qquad ( 13 )$$

In Equation (13), the vector nₘᵢₙ and the angle θ indicate the direction in which the square of the first-order directional differential value becomes minimum and are given by the following Equation (14):

$$\begin{matrix}{n}_{min} = {( \begin{matrix}\frac{- \frac{\partial f}{\partial y}}{\sqrt{{( \frac{\partial f}{\partial x} )}^{2} + {( \frac{\partial f}{\partial y} )}^{2}}} & \frac{\frac{\partial f}{\partial x}}{\sqrt{{( \frac{\partial f}{\partial x} )}^{2} + {( \frac{\partial f}{\partial y} )}^{2}}}\end{matrix} )}^{T} \\ = {( \begin{matrix}- sin θ & cos\end{matrix} θ )}^{T}\end{matrix} \qquad ( 14 )$$

Furthermore, the smoothness constraint on the distribution of the pixel values of the image f may also be changed adaptively to the gradient of the pixel value of f by using Q that is calculated by one of the following Equations (15), (16) and (17):

$$\begin{matrix}Q = w ( x , y ) \vert {( \frac{\partial f}{\partial x} )}^{2} + {( \frac{\partial f}{\partial y} )}^{2} \vert & ( 15 ) \\ Q = w ( x , y ) \vert {( \frac{{\partial }^{2} f}{\partial {x}^{2}} )}^{2} + {( \frac{{\partial }^{2} f}{\partial {y}^{2}} )}^{2} \vert & ( 16 ) \\ Q = w ( x , y ) {\vert \frac{\partial }{\partial {n}_{min}} ( \frac{\partial f}{\partial {n}_{min}} ) \vert}^{m} & ( 17 )\end{matrix}$$

In Equations (15) to (17), w (x, y) is a function representing the gradient of the pixel value and is also a weight function with respect to the constraint. The constraint can be changed adaptively to the gradient of f so that the w (x, y) value is small if the sum of the m^{th} powers of the pixel value gradient components as represented by the following Expression (18) is large but is large if the sum is small:

$${\vert \frac{\partial f}{\partial x} \vert}^{m} + {\vert \frac{\partial f}{\partial y} \vert}^{m} \qquad ( 18 )$$

By introducing such a weight function, it is possible to prevent the restored image f from being smoothed out excessively.

Alternatively, the weight function w(x, y) may also be defined by the magnitude of the m^{th} power of the directional differential value as represented by the following Equation (19) instead of the sum of squares of the luminance gradient components represented by Expression (18):

$${\vert \frac{\partial f}{\partial {n}_{max}} \vert}^{m} = {\vert cos θ \frac{\partial f}{\partial x} + sin θ \frac{\partial f}{\partial y} \vert}^{m} \qquad ( 19 )$$

where the vector nₘₐₓ and the angle θ represent the direction in which the directional differential value becomes maximum and which is given by the following Equation (20):

$$\begin{matrix}{n}_{max} = {( \begin{matrix}\frac{\frac{\partial f}{\partial x}}{\sqrt{{( \frac{\partial f}{\partial x} )}^{2} + {( \frac{\partial f}{\partial y} )}^{2}}} & \frac{\frac{\partial f}{\partial y}}{\sqrt{{( \frac{\partial f}{\partial x} )}^{2} + {( \frac{\partial f}{\partial y} )}^{2}}}\end{matrix} )}^{T} \\ = {( \begin{matrix}cos θ & sin θ\end{matrix} )}^{T}\end{matrix} \qquad ( 20 )$$

The problem of solving Equation (2) by introducing a smoothness constraint on the distribution of the pixel values of a moving picture f as represented by Equations (8), (9) and (13) through (17) can be calculated by a known solution (i.e., a solution for a variational problem such as a finite element method).

As the smoothness constraint on the distribution of image motions included in f, one of the following Equations (21) and (22) may be used:

$$\begin{matrix}Q = {\vert \frac{\partial u}{\partial x} \vert}^{m} + {\vert \frac{\partial u}{\partial y} \vert}^{m} + {\vert \frac{\partial v}{\partial x} \vert}^{m} + {\vert \frac{\partial v}{\partial y} \vert}^{m} & ( 21 ) \\ Q = {\vert \frac{{\partial }^{2} u}{\partial {x}^{2}} \vert}^{m} + {\vert \frac{{\partial }^{2} u}{\partial {y}^{2}} \vert}^{m} + {\vert \frac{{\partial }^{2} v}{\partial {x}^{2}} \vert}^{m} + {\vert \frac{{\partial }^{2} v}{\partial {y}^{2}} \vert}^{m} & ( 22 )\end{matrix}$$

where u is a column vector, of which the elements are x-direction components of motion vectors of respective pixels obtained from the moving picture f, and v is a column vector, of which the elements are y-direction components of motion vectors of respective pixels obtained from the moving picture f.

The smoothness constraint on the distribution of image motions obtained from f does not have to be calculated by Equation (17) or (18) but may also be the first- or second-order directional differential value as represented by the following Equation (23) or (24):

$$\begin{matrix}Q = {\vert \frac{\partial u}{\partial {n}_{min}} \vert}^{m} + {\vert \frac{\partial v}{\partial {n}_{min}} \vert}^{m} & ( 23 ) \\ Q = {\vert \frac{\partial }{\partial {n}_{min}} ( \frac{\partial u}{\partial {n}_{min}} ) \vert}^{m} + {\vert \frac{\partial }{\partial {n}_{min}} ( \frac{\partial v}{\partial {n}_{min}} ) \vert}^{m} & ( 24 )\end{matrix}$$

Still alternatively, as represented by the following Equations (25) to (28), the constraints represented by the Equations (17) through (20) may also be changed adaptively to the gradient of the pixel value of f:

$$\begin{matrix}Q = w ( x , y ) ( {\vert \frac{\partial u}{\partial x} \vert}^{m} + {\vert \frac{\partial u}{\partial y} \vert}^{m} + {\vert \frac{\partial v}{\partial x} \vert}^{m} + {\vert \frac{\partial v}{\partial y} \vert}^{m} ) & ( 25 ) \\ Q = w ( x , y ) ( {\vert \frac{{\partial }^{2} u}{\partial {x}^{2}} \vert}^{m} + {\vert \frac{{\partial }^{2} u}{\partial {y}^{2}} \vert}^{m} + {\vert \frac{{\partial }^{2} v}{\partial {x}^{2}} \vert}^{m} + {\vert \frac{{\partial }^{2} v}{\partial {y}^{2}} \vert}^{m} ) & ( 26 ) \\ Q = w ( x , y ) ( {\vert \frac{\partial u}{\partial {n}_{min}} \vert}^{m} + {\vert \frac{\partial v}{\partial {n}_{min}} \vert}^{m} ) & ( 27 ) \\ Q = w ( x , y ) ( {\vert \frac{\partial }{\partial {n}_{min}} ( \frac{\partial u}{\partial {n}_{min}} ) \vert}^{m} + {\vert \frac{\partial }{\partial {n}_{min}} ( \frac{\partial v}{\partial {n}_{min}} ) \vert}^{m} ) & ( 28 )\end{matrix}$$

where w(x, y) is the same as the weight function on the gradient of the pixel value of f and is defined by either the sum of the m^{th} powers of pixel value gradient components as represented by Expression (18) or the m^{th} power of the directional differential value represented by Equation (19).

By introducing such a weight function, it is possible to prevent the motion information of f from being smoothed out unnecessarily. As a result, it is possible to avoid an unwanted situation where the restored image f is smoothed out excessively.

In dealing with the problem of solving Equation (2) by introducing the smoothness constraint on the distribution of motions obtained from the image f as represented by Equations (21) through (28), the image f to be restored and the motion information (u, v) depend on each other, and therefore, more complicated calculations need to be done compared to the situation where the smoothness constraint on f is used.

To avoid such an unwanted situation, the calculations may also be done by a known solution (i.e., a solution for a variational problem using an EM algorithm). In that case, to perform iterative calculations, the initial values of the image f to be restored and the motion information (u, v) are needed. As the initial f value, an interpolated enlarged version of the input image may be used.

On the other hand, as the motion information, what has been calculated by the motion detector 201 using Equation (1) or (2) may be used. In that case, if the restoration processor 202 solves Equation (2) by introducing the smoothness constraint on the distribution of motions obtained from the image f as in Equations (21) through (28) and as described above, the image quality can be improved as a result of the super-resolution processing.

The image generating section 108 may perform its processing by using, in combination, the smoothness constraint on the distribution of pixel values as represented by one of Equations (8), (9) and (13) through (17) and the smoothness constraint on the distribution of motions as represented by Equations (21) through (28) as in the following Equation (29):

Q=λ₁Q_{f}+λ₂Qᵤᵥ (29)

where Qf is the smoothness constraint on the pixel value gradient of f, Quv is the smoothness constraint on the distribution of image motions obtained from f, and λ1 and λ2 are weights added to the constraints Qf and Quv, respectively.

The problem of solving Equation (3) by introducing both the smoothness constraint on the distribution of pixel values and the smoothness constraint on the distribution of image motions can also be calculated by a known solution (i.e., a solution for a variational problem using an EM algorithm).

The constraint on the motion does not have to be the constraint on the smoothness of the distribution of motion vectors as represented by Equations (21) through (28) but may also use the residual between two associated points (i.e., the difference in pixel value between the starting and end points of a motion vector) as an estimate value so as to reduce the residual as much as possible. If f is represented by the function f(x, y, z), the residual between the two associated points can be represented by the following Expression (30):

ƒ(x+u, y+v, t+Δt)−ƒ(x,y,t) (30)

If f is regarded as a vector that is applied to the entire image, the residual of each pixel can be represented as a vector as in the following Expression (31):

Hₘf (31)

The sum of squared residuals can be represented by the following Equation (32):

(Hₘf)²=f^{T}Hₘ^{T}Hₘf (32)

In Expressions (31) and (32), Hₘ represents a matrix consisting of the number of elements of the vector f (i.e., the total number of pixels in the temporal or spatial range)×the number of elements of f. In Hₘ, only two elements of each row that are associated with the starting and end points of a motion vector have non-zero values, while the other elements have a zero value. Specifically, if the motion vector has an integral precision, the elements associated with the starting and end points have values of −1 and 1, respectively, but the other elements have a value of 0.

On the other hand, if the motion vector has a subpixel precision, multiple elements associated with multiple pixels around the end point will have non-zero values according to the subpixel component value of the motion vector.

Optionally, the constraint may be represented by the following Equation (33) with Equation (32) replaced by Qm:

Q=λ₁Q_{f}+λ₂Qᵤᵥ+λ₃Qₘ (33)

where λ3 is the weight with respect to the constraint Qm.

According to the method described above, by using the motion information that has been obtained from low-resolution moving pictures of R and B, a G moving picture that has been captured by an image sensor with a Bayer arrangement (i.e., an image that has been exposed over multiple frames) can have its temporal and spatial resolutions increased.

<How to Restore R and B Pixel Values of Each Pixel>

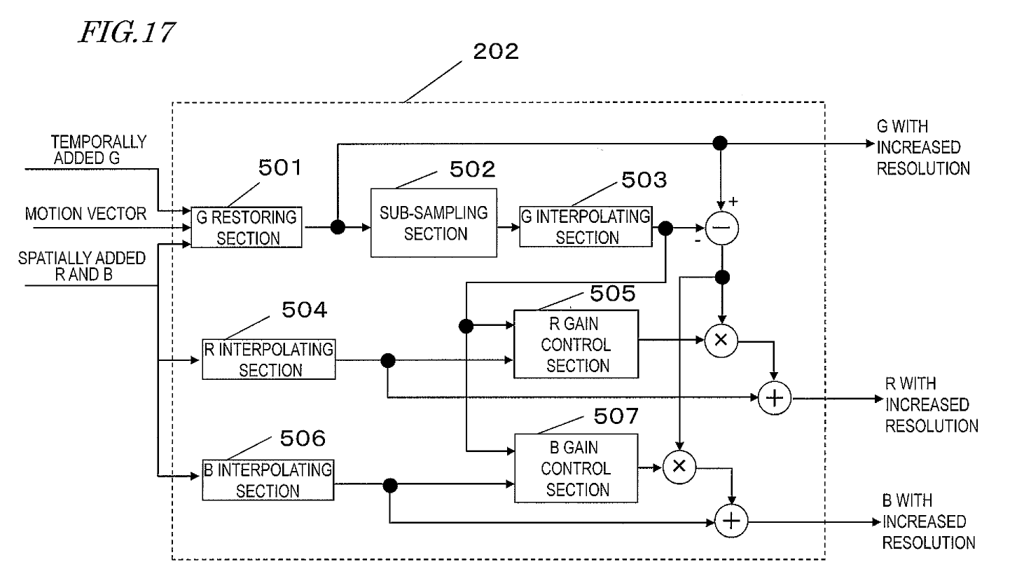

FIG. 17 illustrates an exemplary configuration for the restoration processor 202.

As for R and B, the high frequency components of G that has had its temporal and spatial resolutions increased as described above are superposed on the R and B images that have been interpolated and enlarged as shown in FIG. 17. As a result, R and B images, of which the resolutions have been further increased through simple processing, can be output as a color image. In that case, by controlling the amplitudes of high frequency components to superpose according to the local correlation between R, G and B other than in a high frequency range (i.e., in middle to low frequency ranges), an image with natural appearance can have an increased resolution with the generation of false colors minimized.

In addition, since the high frequency components of G are superposed, the resolutions of R and B can be increased with more stability. Hereinafter, it will be described exactly how to increase the resolutions.

The restoration processor 202 includes a G restoring section 501, a sub-sampling section 502, a G interpolating section 503, an R interpolating section 504, an R gain control section 505, a B interpolating section 506, and a B gain control section 507.

The G restoring section 501 restores G as described above.

The sub-sampling section 502 reduces the resolution of G that has been increased to the same number of pixels as that of R and B by sub-sampling process.

The G interpolating section 503 calculates the pixel values of pixels that have been lost through the sub-sampling process by interpolation.

The R interpolating section 504 makes interpolation on R.

The R gain control section 505 calculates a gain coefficient with respect to the high frequency components of G to be superposed on R.

The B interpolating section 506 makes interpolation on B.

The B gain control section 507 calculates a gain coefficient with respect to the high frequency components of G to be superposed on B.

Hereinafter, it will be described how this restoration processor 202 operates.

The G restoring section 501 restores G as an image with a high resolution and a high frame rate, and outputs a result of the restoration as the G component of the output image to the sub-sampling section 502. In response, the sub-sampling section 502 sub-samples the G component that has been supplied.

The G interpolating section 503 makes interpolation on the G image that has been sub-sampled by the sub-sampling section 502. As a result, the pixel values of pixels that have been once lost as a result of the sub-sampling can be calculated by making interpolation on surrounding pixel values. And by subtracting the G image that has been subjected to the interpolation from the output of the G restoring section 501, the high spatial frequency components of G can be extracted.

Meanwhile, the R interpolating section 504 interpolates and enlarges the R image that has been spatially added so that the R image has the same number of pixels as G. The R gain control section 505 calculates a local correlation coefficient between the output of the G interpolating section 503 (i.e., the low spatial frequency component of G) and the output of the R interpolating section 504. As the local correlation coefficient, the correlation coefficient of 3×3 pixels surrounding a pixel in question (x, y) may be calculated by the following Equation (34):

$$ρ = \frac{{\sum }_{i = - 1 , 0 , 1}^{3} {\sum }_{j = - 1 , 0 , 1}^{3} ( R ( x + i , y + j ) - \overline{R} ) ( G ( x + i , y + j ) - \overline{G} )}{\begin{matrix}\sqrt{{\sum }_{i = - 1 , 0 , 1}^{3} {\sum }_{j = - 1 , 0 , 1}^{3} {( R ( x + i , y + j ) - \overline{R} )}^{2}} \\ \sqrt{{\sum }_{i = - 1 , 0 , 1}^{3} {\sum }_{j = - 1 , 0 , 1}^{3} {( G ( x + i , y + j ) - \overline{G} )}^{2}}\end{matrix}} \\ where \text{:} \\ \overline{R} = \frac{1}{9} {\sum }_{i = - 1 , 0 , 1}^{3} {\sum }_{j = - 1 , 0 , 1}^{3} R ( x + i , y + j ) ; and \\ \overline{G} = \frac{1}{9} {\sum }_{i = - 1 , 0 , 1}^{3} {\sum }_{j = - 1 , 0 , 1}^{3} G ( x + i , y + j ) \qquad ( 34 )$$

The correlation coefficient that has been thus calculated between the low spatial frequency components of R and G is multiplied by the high spatial frequency component of G and then the product is added to the output of the R interpolating section 504, thereby increasing the resolution of the R component.

The B component is also processed in the same way as the R component. Specifically, the B interpolating section 506 interpolates and enlarges the B image that has been spatially added so that the B image has the same number of pixels as G. The B gain control section 507 calculates a local correlation coefficient between the output of the G interpolating section 503 (i.e., the low spatial frequency component of G) and the output of the B interpolating section 506. As the local correlation coefficient, the correlation coefficient of 3×3 pixels surrounding the pixel in question (x, y) may be calculated by the following Equation (35):

$$ρ = \frac{{\sum }_{i = - 1 , 0 , 1}^{3} {\sum }_{j = - 1 , 0 , 1}^{3} ( B ( x + i , y + j ) - \overline{B} ) ( G ( x + i , y + j ) - \overline{G} )}{\begin{matrix}\sqrt{{\sum }_{i = - 1 , 0 , 1}^{3} {\sum }_{j = - 1 , 0 , 1}^{3} {( B ( x + i , y + j ) - \overline{B} )}^{2}} \\ \sqrt{{\sum }_{i = - 1 , 0 , 1}^{3} {\sum }_{j = - 1 , 0 , 1}^{3} {( G ( x + i , y + j ) - \overline{G} )}^{2}}\end{matrix}} \\ where \text{:} \\ \overline{B} = \frac{1}{9} {\sum }_{i = - 1 , 0 , 1}^{3} {\sum }_{j = - 1 , 0 , 1}^{3} B ( x + i , y + j ) ; and \\ \overline{G} = \frac{1}{9} {\sum }_{i = - 1 , 0 , 1}^{3} {\sum }_{j = - 1 , 0 , 1}^{3} G ( x + i , y + j ) . \qquad ( 35 )$$

The correlation coefficient that has been thus calculated between the low spatial frequency components of B and G is multiplied by the high spatial frequency component of G and then the product is added to the output of the B interpolating section 506, thereby increasing the resolution of the B component.

The method of calculating G, R and B pixel values that is used by the restoration section 202 as described above is only an example. Thus, any other calculating method may be adopted as well. For example, the restoration section 202 may calculate R, G and B pixel values at the same time.

Specifically, in that case, the restoration section 202 sets an evaluation function J representing the degree of similarity between the spatial variation patterns of respective color image components the target color image g should have, and looks for the target image g that minimizes the evaluation function J. If their spatial variation patterns are similar, it means that the blue, red and green images cause similar spatial variations. The following Equation (36) shows an example of the evaluation function J:

J(g)=∥H_{R}R_{H}−R_{L}∥²+∥H_{G}G_{H}−G_{L}∥²+∥H_{B}B_{H}−B_{L}∥²+λ_{θ}∥Q_{S}C_{θ}g∥^{p}+λ_{φ}∥Q_{S}C_{φ}g∥^{p}+λᵣ∥Q_{S}Cᵣg∥^{p} (36)

The evaluation function J is defined herein as a function of respective color images in red, green and blue that form the high-resolution color image g to generate (i.e., the target image). Those color images will be represented herein by their image vectors R_{H}, G_{E} and B_{H}, respectively. In Equation (36), H_{R}, H_{G} and H_{B} represent a resolution decreasing conversion from the respective color images R_{H}, G_{H} and B_{H} of the target image g into the respective input color images R_{L}, G_{L} and B_{L} (which are also represented by their vectors). In this case, H_{R}, H_{G} and H_{B} represent resolution decreasing conversions that are given by the following Equations (37), (38) and (39):

$$\begin{matrix}{R}_{L} ( {x}_{RL} , {y}_{RL} ) = {\sum }_{( {x}^{′} , {y}^{′} ) ∈ C} {w}_{R} ( {x}^{′} , {y}^{′} ) \cdot {R}_{H} ( x ( {x}_{RL} ) + {x}^{′} , y ( {y}_{RL} ) + {y}^{′} ) & ( 37 ) \\ {G}_{L} ( {x}_{GL} , {y}_{GL} ) = {\sum }_{( {x}^{′} , {y}^{′} ) ∈ C} {w}_{G} ( {x}^{′} , {y}^{′} ) \cdot {G}_{H} ( x ( {x}_{GL} ) + {x}^{′} , y ( {y}_{GL} ) + {y}^{′} ) & ( 38 ) \\ {B}_{L} ( {x}_{BL} , {y}_{BL} ) = {\sum }_{( {x}^{′} , {y}^{′} ) ∈ C} {w}_{B} ( {x}^{′} , {y}^{′} ) \cdot {B}_{H} ( x ( {x}_{BL} ) + {x}^{′} , y ( {y}_{BL} ) + {y}^{′} ) & ( 39 )\end{matrix}$$

The pixel value of each input image is the sum of weighted pixel values in a local area that surrounds an associated location in the target image.

In these Equations (37), (38) and (39), R_{H}(x, y), G_{H}(x, y) and B_{H}(x, y) represent the respective values of red (R), green (G) and blue (B) pixels at a pixel location (x, y) on the target image g. Also, H_{L}(x_{RL}, y_{RL}), G_{L}(x_{GL}, y_{GL}) and B_{L}(x_{BL}, y_{BL}) represent the pixel value at a pixel location (x_{RL}, y_{RL}) on the red input image, the pixel value at a pixel location (x_{GL}, y_{GL}) on the green input image, and the pixel value at a pixel location (x_{BL}, y_{BL}) on the blue input image, respectively. x(x_{RL}) and y(y_{RL}) represent the x and y coordinates at a pixel location on the target image that is associated with the pixel location (x_{RL}, y_{RL}) on the input red image. x(x_{GL}) and y(y_{GL}) represent the x and y coordinates at a pixel location on the target image that is associated with the pixel location (x_{GL}, y_{GL}) on the input green image. And x(x_{BL}) and y(y_{BL}) represent the x and y coordinates at pixel location on the target image that is associated with the pixel location (x_{BL}, y_{BL}) on the input blue image. Also, w_{R}, w_{G} and w_{B} represent the weight functions of pixel values of the target image, which are associated with the pixel values of the red, green and blue images, respectively. It should be noted that (x′, y′)εC represents the range of the local area where w_{R}, w_{G} and w_{B} are defined.

The sum of squared differences between the pixel values at multiple pixel locations on the low resolution image and the ones at their associated pixel locations on the input image is set to be an evaluation condition for the evaluation function (see the first, second and third terms of Equation (30)). That is to say, these evaluation conditions are set by a value representing the magnitude of the differential vector between a vector consisting of the respective pixel values of the low resolution image and a vector consisting of the respective pixel values of the input image.

The fourth term Qₛ of Equation (36) is an evaluation condition for evaluating the spatial smoothness of a pixel value.

Qₛ₁ and Qₛ₂, which are examples of Qₛ, are represented by the following Equations (40) and (41), respectively:

$${Q}_{s 1} = {\sum }_{x} {\sum }_{y} [ {λ}_{θ} ( x , y ) \cdot {\{ \begin{matrix}4 \cdot {θ}_{H} ( x , y ) - {θ}_{H} ( x , y - 1 ) - {θ}_{H} ( x , y + 1 ) - \\ {θ}_{H} ( x - 1 , y ) - {θ}_{H} ( x + 1 , y )\end{matrix} \}}^{2} + {λ}_{ϕ} ( x , y ) \cdot {\{ \begin{matrix}4 \cdot {ϕ}_{H} ( x , y ) - {ϕ}_{H} ( x , y - 1 ) - {ϕ}_{H} ( x , y + 1 ) - \\ {ϕ}_{H} ( x - 1 , y ) - {ϕ}_{H} ( x + 1 , y )\end{matrix} \}}^{2} + {λ}_{r} ( x , y ) \cdot {\{ \begin{matrix}4 \cdot {r}_{H} ( x , y ) - {r}_{H} ( x , y - 1 ) - {r}_{H} ( x , y + 1 ) - \\ {r}_{H} ( x - 1 , y ) - {r}_{H} ( x + 1 , y )\end{matrix} \}}^{2} ] \qquad ( 40 )$$

In Equation (40), θ_{H}(x, y), ψ_{H}(x, y) and r_{H}(x, y) are coordinates when a position in a three-dimensional orthogonal color space (i.e., a so-called “RGB color space”) that is represented by red, green and blue pixel values at a pixel location (x, y) on the target image is represented by a spherical coordinate system (θ, ψ, r) corresponding to the RGB color space. In this case, θ_{H}(x, y) and ψ_{H}(x, y) represent two kinds of arguments and r_{H}(x, y) represents the radius.

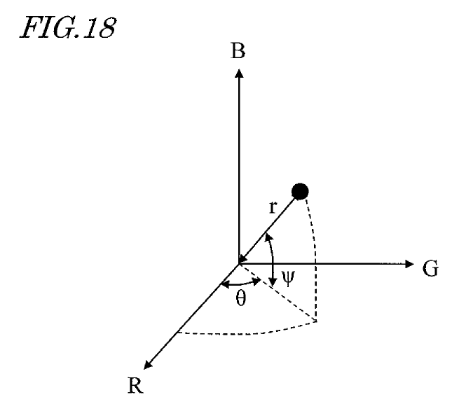

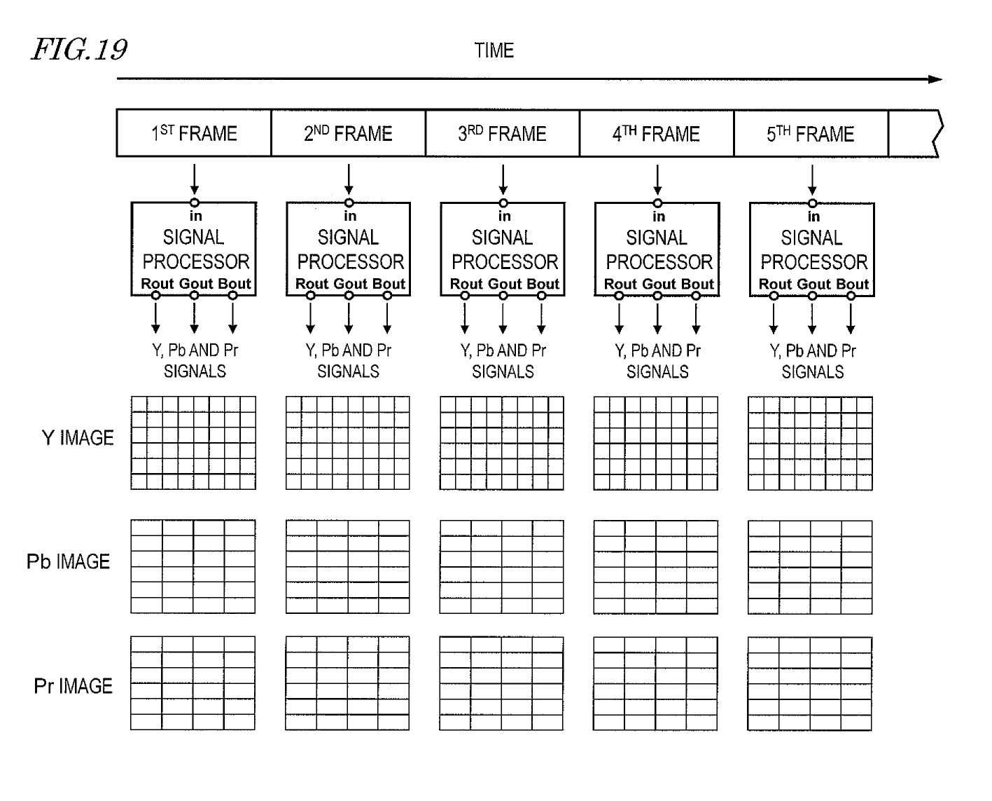

FIG. 18 illustrates an exemplary correspondence between the RGB color space and the spherical coordinate system (θ, ψ, r).

In the example illustrated in FIG. 18, the direction in which θ=0 degrees and ψ=0 degrees is supposed to be positive R-axis direction in the RGB color space, and the direction in which θ=90 degrees and ψ=0 degrees is supposed to be positive G-axis direction in the RGB color space. However, the reference directions of the arguments do not have to be the ones shown in FIG. 18 but may also be any other directions. In accordance with such correspondence, red, green and blue pixel values, which are coordinates in the RGB color space, are converted into coordinates in the spherical coordinate system (θ, ψ, r).

Suppose the pixel value of each pixel of the target image is represented by a three-dimensional vector in the RGB color space. In that case, if the three-dimensional vector is represented by the spherical coordinate system (θ, ψ, r) that is associated with the RGB color space, then the brightness (which is synonymous with the signal intensity and the luminance) of the pixel corresponds to the r-axis coordinate representing the magnitude of the vector. On the other hand, the directions of vectors representing the color (i.e., color information including the hue, color difference and color saturation) of the pixel are defined by θ-axis and ψ-axis coordinate values. That is why by using the spherical coordinate system (θ, ψ, r), the three parameters r, θ and ψ that define the brightness and color of each pixel can be dealt with independently of each other.

Equation (40) defines the sum of squared second-order differences in the xy space direction between pixel values that are represented by the spherical coordinate system of the target image. Equation (40) also defines a condition Qₛ₁ on which the more uniformly the spherical coordinate system pixel values, which are associated with spatially adjacent pixels in the target image, vary, the smaller their values become. Generally speaking, if pixel values vary uniformly, then it means that the colors of those pixels are continuous with each other. Also, if the condition Qₛ₁ should have a small value, then it means that the colors of spatially adjacent pixels in the target image should be continuous with each other.

In an image, the variation in the brightness of a pixel and the variation in the color of that pixel may be caused by two physically different events. That is why by setting a condition on the continuity of a pixel's brightness (i.e., the degree of uniformity of the variation in r-axis coordinate value) as in the third term in the bracket of Equation (40) and a condition on the continuity of the pixel's color (i.e., the degree of uniformity in the variations in θ- and ψ-axis coordinate values) as in the first and second terms in the bracket of Equation (40) independently of each other, the target image quality can be achieved more easily.

λθ(x, y), λψ(x, y) and λᵣ(x, y) represent the weights to be applied to a pixel location (x, y) on the target image with respect to the conditions that have been set with the θ-, ψ- and r-axis coordinate values, respectively. These values are determined in advance. To simplify the computation, these weights may be set to be constant irrespective of the pixel location or the frame so that λθ(x, y)=λψ, (x, y)=1.0, and λᵣ(x, y)=0.01, for example. Alternatively, these weights may be set to be relatively small in a portion of the image where it is known in advance that pixel values should be discontinuous, for instance. Optionally, pixel values can be determined to be discontinuous with each other if the absolute value of the difference or the second-order difference between the pixel values of two adjacent pixels in a frame image of the input image is equal to or greater than a particular value.

It is preferred that the weights applied to the condition on the continuity of the color of pixels be heavier than the weights applied to the condition on the continuity of the brightness of the pixels. This is because the brightness of pixels in an image tends to vary more easily (i.e., vary less uniformly) than its color when the orientation of the subject's surface (i.e., a normal to the subject's surface) changes due to the unevenness or the movement of the subject's surface.

In Equation (40), the sum of squared second-order differences in the xy space direction between the pixel values, which are represented by the spherical coordinate system on the target image, is set as the condition Qₛ₁. Alternatively, the sum of the absolute values of the second-order differences or the sum of squared first-order differences or the sum of the absolute values of the first-order differences may also be set as that condition Qₛ₁.

Also, in the foregoing description, the color space condition is set using the spherical coordinate system (θ, ψ, r) that is associated with the RGB color space. However, the coordinate system to use does not always have to be the spherical coordinate system. Rather the same effects as what has already been described can also be achieved by setting a condition on a different orthogonal coordinate system with axes of coordinates that make the brightness and color of pixels easily separable from each other.

The axes of coordinates of the different orthogonal coordinate system may be set in the directions of eigenvectors (i.e., may be the axes of eigenvectors), which are defined by analyzing the principal components of the RGB color space frequency distribution of pixel values that are included in the input moving picture or another moving picture as a reference.

$${Q}_{s 2} = {\sum }_{x} {\sum }_{y} [ {λ}_{C 1} ( x , y ) \cdot {\{ \begin{matrix}4 \cdot {C}_{1} ( x , y ) - {C}_{1} ( x , y - 1 ) - {C}_{1} ( x , y + 1 ) - \\ {C}_{1} ( x - 1 , y ) - {C}_{1} ( x + 1 , y )\end{matrix} \}}^{2} + {λ}_{C 2} ( x , y ) \cdot {\{ \begin{matrix}4 \cdot {C}_{2} ( x , y ) - {C}_{2} ( x , y - 1 ) - {C}_{2} ( x , y + 1 ) - \\ {C}_{2} ( x - 1 , y ) - {C}_{2} ( x + 1 , y )\end{matrix} \}}^{2} + {λ}_{C 3} ( x , y ) \cdot {\{ \begin{matrix}4 \cdot {C}_{3} ( x , y ) - {C}_{3} ( x , y - 1 ) - {C}_{3} ( x , y + 1 ) - \\ {C}_{3} ( x - 1 , y ) - {C}_{3} ( x + 1 , y )\end{matrix} \}}^{2} ] \qquad ( 41 )$$

In Equation (41), C₁(x, y), C₂(x, y) and C₃(x, y) represent rotational transformations that transform RGB color space coordinates, which are red, green and blue pixel values at a pixel location (x, y) on the target image, into coordinates on the axes of C₁, C₂ and C₃ coordinates of the different orthogonal coordinate system.

Equation (41) defines the sum of squared second-order differences in the xy space direction between pixel values of the target image that are represented by the different orthogonal coordinate system. Also, Equation (41) defines a condition Qₛ₂. In this case, the more uniformly the pixel values of spatially adjacent pixels in each frame image of the target image, which are represented by the different orthogonal coordinate system, vary (i.e., the more continuous those pixel values), the smaller the value of the condition Qₛ₂.

And if the value of the condition Qₛ₂ should be small, it means that the colors of spatially adjacent pixels on the target image should have continuous colors.

λ_{C1}(x, y), λ_{C2}(x, y) and λ_{C3}(x, y) are weights applied to a pixel location (x, y) on the target image with respect to a condition that has been set using coordinates on the C₁, C₂ and C₃ axes and need to be determined in advance.

If the C₁, C₂ and C₃ axes are axes of eigenvectors, then the λ_{C1}(x, y), λ_{C2}(x, y) and λ_{C3}(x, y) values are preferably set along those axes of eigenvectors independently of each other. Then, the best λ values can be set according to the variance values that are different from one axis of eigenvectors to another. Specifically, in the direction of a non-principal component, the variance should be small and the sum of squared second-order differences should decrease, and therefore, the λ value is increased. Conversely, in the principal component direction, the λ value is decreased.

Two conditions Qₛ₁ and Qₛ₂ have been described as examples. And the condition Qₛ may be any of the two conditions Qₛ₁ and Qₛ₂ described above.

For example, if the condition Qₛ₁ defined by Equation (40) is adopted, the spherical coordinate system (θ, ψ, r) is preferably introduced. Then, the condition can be set using the coordinates on the θ- and ψ-axes that represent color information and the coordinate on the r-axis that represents the signal intensity independently of each other. In addition, in setting the condition, appropriate weight parameters λ can be applied to the color information and the signal intensity, respectively. As a result, an image of quality can be generated more easily, which is beneficial.

On the other hand, if the condition Qₛ₂ defined by Equation (41) is adopted, then the condition is set with coordinates of a different orthogonal coordinate system that is obtained by performing a linear (or rotational) transformation on RGB color space coordinates. Consequently, the computation can be simplified, which is also advantageous.

On top of that, by defining the axes of eigenvectors as the axes of coordinates C₁, C₂ and C₃ of the different orthogonal coordinate system, the condition can be set using the coordinates on the axes of eigenvectors that reflect a color variation to affect an even greater number of pixels. As a result, the quality of the target image obtained should improve compared to a situation where the condition is set simply by using the pixel values of the respective color components in red, green and blue.

The evaluation function J does not have to be the one described above. Alternatively, terms of Equation (36) may be replaced with terms of a similar equation or another term representing a different condition may be newly added thereto.

Next, respective pixel values of a target image that will make the value of the evaluation function J represented by Equation (36) as small as possible (and will preferably minimize it) are obtained, thereby generating respective color images R_{H}, G_{H} and B_{H} of the target image. Alternatively, the target image g that will minimize the evaluation function J may also be obtained by solving the following Equation (42) in which every J differentiated by the pixel value component of each color image R_{H}, G_{H}, B_{H} is supposed to be zero. Still alternatively, the target image g may also be obtained by an optimizing technique that requires iterative computations such as the steepest gradient method.

$$\frac{\partial J}{\partial {R}_{H} ( x , y )} = \frac{\partial J}{\partial {G}_{H} ( x , y )} = \frac{\partial J}{\partial {B}_{H} ( x , y )} = 0 \qquad ( 42 )$$

In the preferred embodiment described above, the color image to output is supposed to consist of R, G and B components. However, the color image may also be represented by a luminance signal Y and two color difference signals Pb and Pr. FIG. 19 illustrates luminance (Y) images, Pb images and Pr images to be output by the signal processor 82. The Pb and Pr images have a half as large a number of horizontal pixels as the Y image. The Y, Pb and Pr images and the R, G and B images satisfy the relation represented by the following Equation (43).

That is to say, the change of variables represented by the following Equation (44) can be done based on Equations (42) and (43):

$$\begin{matrix} ( \begin{matrix}R \\ G \\ B\end{matrix} ) = ( \begin{matrix}1 & - 0.00015 & 1.574765 \\ 1 & - 0.18728 & - 0.46812 \\ 1 & 1.85561 & 0.000106\end{matrix} ) ( \begin{matrix}Y \\ Pb \\ Pr\end{matrix} ) & ( 43 ) \\ ( \begin{matrix}\frac{\partial J}{\partial {Y}_{H} ( x , y )} \\ \frac{\partial J}{\partial {Pb}_{H} ( x , y )} \\ \frac{\partial J}{\partial {Pr}_{H} ( x , y )}\end{matrix} ) = ( \begin{matrix}\frac{\partial J}{\partial {R}_{H} ( x , y )} \frac{\partial {R}_{H} ( x , y )}{\partial {Y}_{H} ( x , y )} + \frac{\partial J}{\partial {G}_{H} ( x , y )} \frac{\partial {G}_{H} ( x , y )}{\partial {Y}_{H} ( x , y )} + \frac{\partial J}{\partial {B}_{H} ( x , y )} \frac{\partial {B}_{H} ( x , y )}{\partial {Y}_{H} ( x , y )} \\ \frac{\partial J}{\partial {R}_{H} ( x , y )} \frac{\partial {R}_{H} ( x , y )}{\partial {Pb}_{H} ( x , y )} + \frac{\partial J}{\partial {G}_{H} ( x , y )} \frac{\partial {G}_{H} ( x , y )}{\partial {Pb}_{H} ( x , y )} + \frac{\partial J}{\partial {B}_{H} ( x , y )} \frac{\partial {B}_{H} ( x , y )}{\partial {Pb}_{H} ( x , y )} \\ \frac{\partial J}{\partial {R}_{H} ( x , y )} \frac{\partial {R}_{H} ( x , y )}{\partial {Pr}_{H} ( x , y )} + \frac{\partial J}{\partial {G}_{H} ( x , y )} \frac{\partial {G}_{H} ( x , y )}{\partial {Pr}_{H} ( x , y )} + \frac{\partial J}{\partial {B}_{H} ( x , y )} \frac{\partial {B}_{H} ( x , y )}{\partial {Pr}_{H} ( x , y )}\end{matrix} ) = ( \begin{matrix}1 & 1 & 1 \\ - 0.00015 & - 0.18728 & 1.85561 \\ 1.574765 & - 0.46812 & 0.000106\end{matrix} ) ( \begin{matrix}\frac{\partial J}{\partial {R}_{H} ( x , y )} \\ \frac{\partial J}{\partial {G}_{H} ( x , y )} \\ \frac{\partial J}{\partial {B}_{H} ( x , y )}\end{matrix} ) = 0 & ( 44 )\end{matrix}$$

Furthermore, by using the relations represented by the following Equations (45) with the fact that Pb and Pr have a half the number of horizontal pixels as Y taken into consideration, simultaneous equations can be formulated with respect to Y_{H}, Pb_{L} and Pr_{L}.

Pb_{L}(x+0.5)=0.5(Pb_{H}(x)+Pb_{H}(x+1))Pr_{L}(x+0.5)=0.5(Pr_{H}(x)+Pr_{H}(x+1)) (45)

In that case, the total number of variables to be obtained by solving the simultaneous equations can be reduced to two-thirds compared to the situation where the color image to output consists of R, G and B components. As a result, the computational complexity can be cut down.

As described above, according to this preferred embodiment, a moving picture can be shot with high sensitivity so as to achieve high color reproducibility, a high resolution and a high frame frequency.

### Embodiment 2

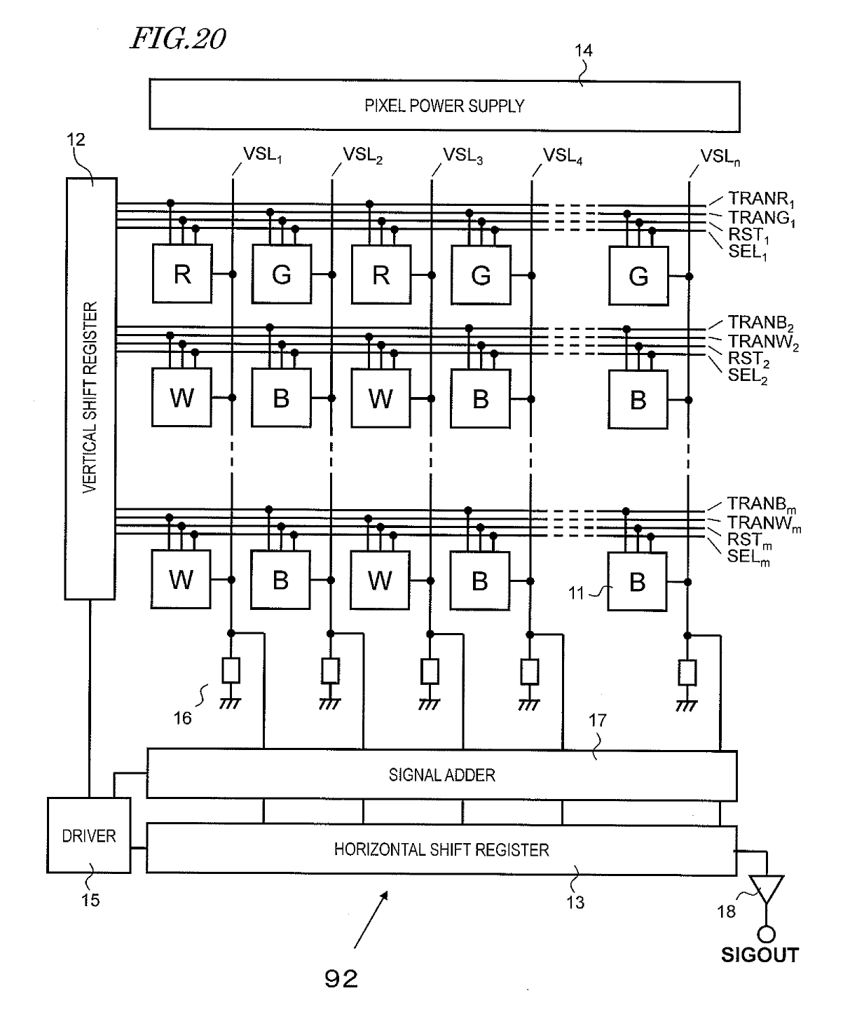

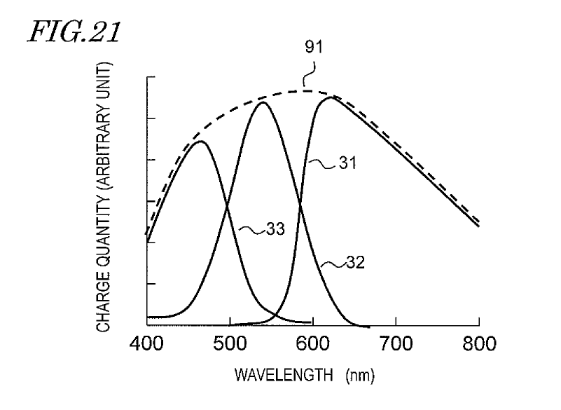

FIG. 20 illustrates a configuration for a solid-state image sensor 92 as a second preferred embodiment of the present invention. A number of pixels, which have sensitivities in three wavelength ranges that are respectively associated with the three primary colors of light (i.e., R, G and B), and white (W) pixels, which exhibit high sensitivity over the entire visible radiation range, are arranged two-dimensionally to form a matrix pattern. FIG. 21 shows how different the photoelectric conversion property 91 of the W pixels and the photoelectric conversion properties 31, 32 and 33 of the R, G and B pixels are.

The solid-state image sensor 92 of this preferred embodiment has peripheral circuits and pixel circuits that have the same configurations, and operate in the same way, as their counterparts of the first preferred embodiment described above. Also, as in FIG. 7 illustrating the first preferred embodiment, a system is set up by connecting the signal processor 82 and the timing generator 83 to the output terminal SIGOUT of the solid-state image sensor. In the following description, an image obtained from a group of pixels with the sensitivity property of the color white (W) will be referred to herein as a “W image”.

When shooting a subject with high illuminance in a bright shooting environment, the solid-state image sensor 92 also reads pixel signals from all pixels by activating, on a frame-by-frame basis, TRANR, TRANG, TRANB and TRANW, to which the respective gate terminals of the transfer transistors 22 of the R, G, B and W pixels are connected.

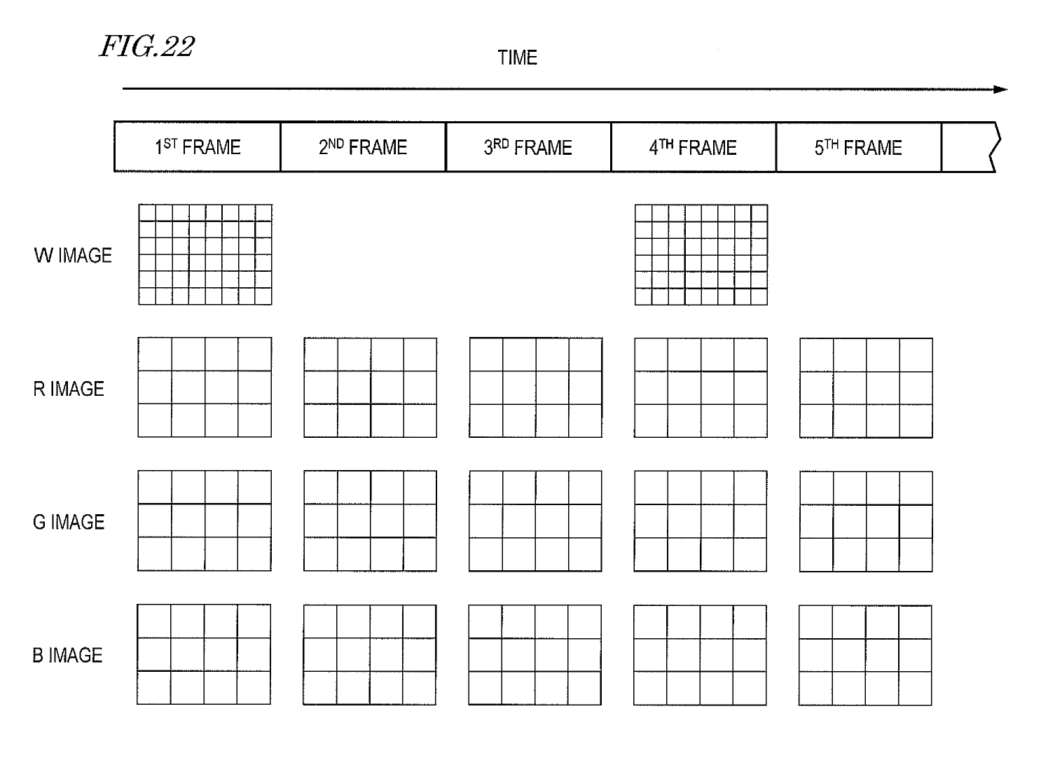

On the other hand, when shooting a subject with low illuminance in a dark shooting environment, the modes of operation are changed into a high sensitivity mode, in which TRANR, TRANG and TRANB are activated every frame and TRANW is activated every three frames. Furthermore, the signal adder 17 is also activated to add together every four R pixels, every four G pixels and every four B pixels. FIG. 22 illustrates frames of respective images that have been output by the image sensor (i.e., the solid-state image sensor 92). As shown in FIG. 22, a W image with the full resolution is output every three frames and R, G and B images with a half vertical resolution and a half horizontal resolution are output every frame.

The signal processor detects the motion of the subject based on the R, G and B images that have been supplied at a high frame frequency, thereby generating an interpolated frame for the W image and increasing its frame frequency. At the same time, the signal processor also generates interpolated pixels for the R, G and B images based on the W image that has been supplied with the full resolution and increases their resolutions.

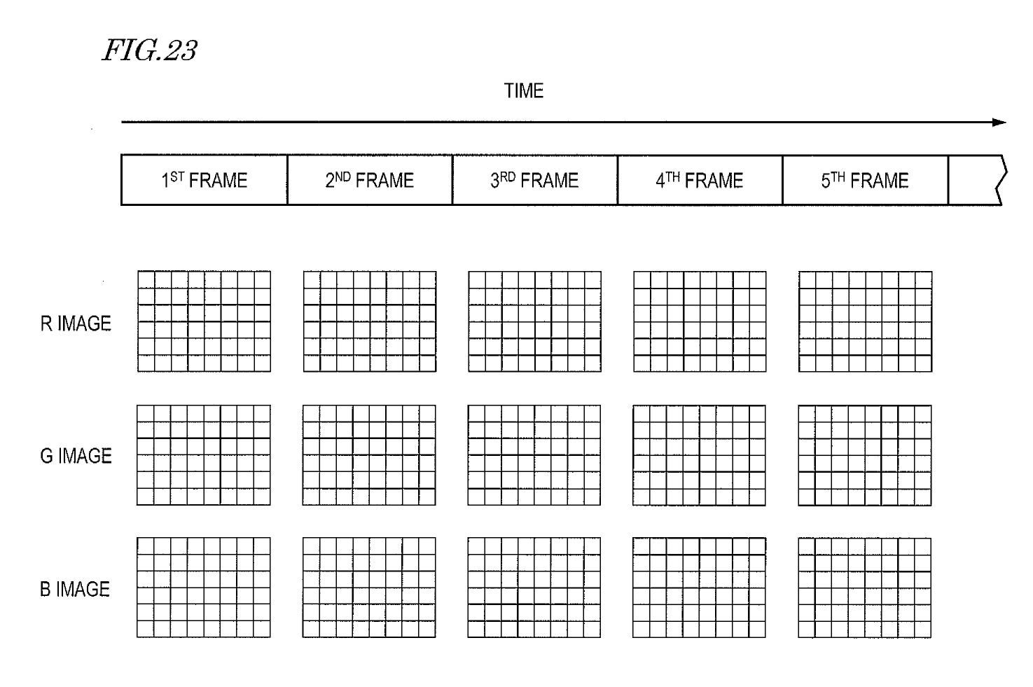

FIG. 23 illustrates R, G and B images to be output from the signal processor 82 with the full resolution and at high frame frequencies. As shown in FIG. 23, a moving picture, of which the R, G and B images all have the full resolution and high frame frequencies, can be obtained. By synthesizing the respective images together, a color moving picture can be obtained.

The method for generating interpolated pixels for the R, G and B images, and increasing their resolutions, based on the W image that has been supplied with the full resolution may be the same as what has already been described for the first preferred embodiment. That is to say, the method for generating interpolated pixels for the R and B images, and increasing their resolutions, based on the G image that has been supplied with the full resolution may be used again as in the first preferred embodiment described above.

According to this preferred embodiment, by arranging W pixels, a moving picture can be shot with even higher sensitivity than in the first preferred embodiment.

### Embodiment 3

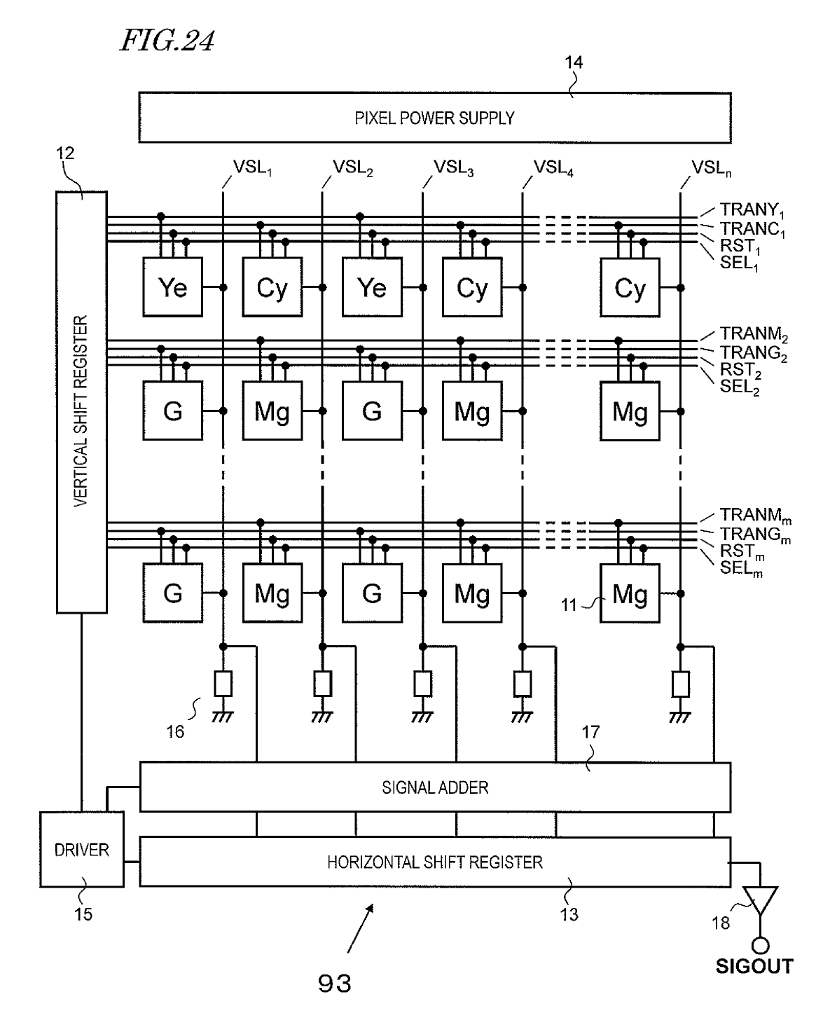

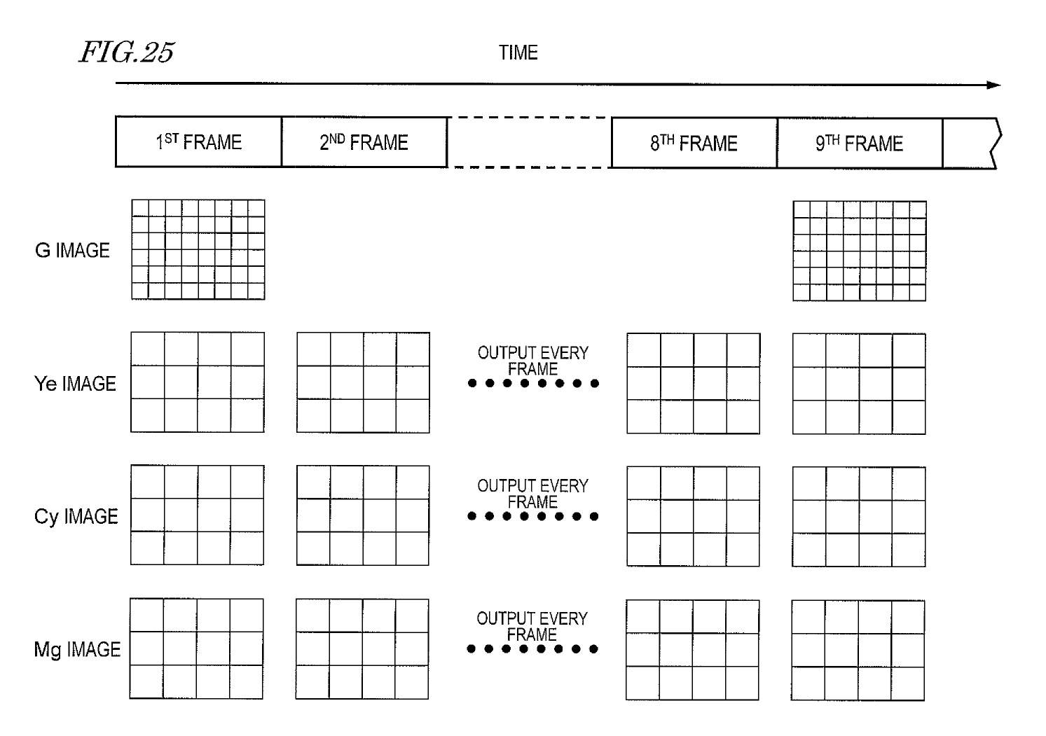

FIG. 24 illustrates a configuration for a solid-state image sensor 93 as a third preferred embodiment of the present invention. A number of pixels, which have sensitivities in three wavelength ranges that are respectively associated with cyan (C), magenta (Mg) and yellow (Ye) that are the complementary colors of R, G and B, and pixels, which have sensitivity in the wavelength range associated with G, are arranged two-dimensionally to form a matrix pattern. It should be noted that cyan (Cy) is the complementary color of R and mainly covers the wavelength ranges that are associated with G and B. The same can be said about the wavelength ranges that are covered by magenta (Mg) and yellow (Ye).

The solid-state image sensor 93 of this preferred embodiment has peripheral circuits and pixel circuits that have the same configurations, and operate in the same way, as their counterparts of the first preferred embodiment described above. Also, as in FIG. 7 illustrating the first preferred embodiment, a system is set up by connecting the signal processor 82 and the timing generator 83 to the output terminal SIGOUT of the solid-state image sensor 93.

When shooting a subject with high illuminance in a bright shooting environment, the solid-state image sensor 93 also reads pixel signals from all pixels by activating, on a frame-by-frame basis, TRANC, TRANM, TRANY and TRANG, to which the respective gate terminals of the transfer transistors 22 of the Cy, Mg, Ye and G pixels are connected.

On the other hand, when shooting a subject with low illuminance in a dark shooting environment, the modes of operation are changed into a high sensitivity mode, in which TRANC, TRANM and TRANY are activated every frame and TRANG is activated every eight frames. Furthermore, the signal adder 17 is also activated to add together every four Cy pixels, every four Mg pixels and every four Ye pixels. FIG. 25 illustrates frames of respective images that have been output by the image sensor (i.e., the solid-state image sensor 92). As shown in FIG. 25, a G image with the full resolution is output every eight frames and Cy, Mg and Ye images with a half vertical resolution and a half horizontal resolution are output every frame.

The signal processor detects the motion of the subject based on the Cy, Mg and Ye images that have been supplied at a high frame frequency, thereby generating an interpolated frame for the G image and increasing its frame frequency. At the same time, the signal processor also generates interpolated pixels for the Cy, Mg and Ye images based on the G image that has been supplied with the full resolution and increases their resolutions.

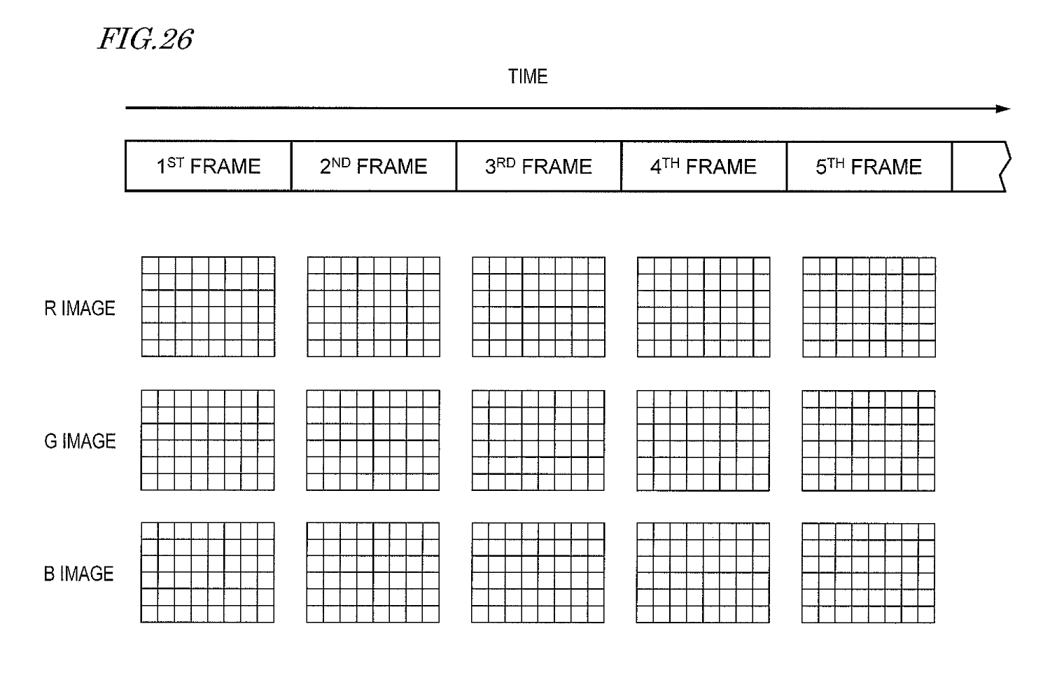

FIG. 26 illustrates R, G and B images to be output from the signal processor 82 with the full resolution and at high frame frequencies. As shown in FIG. 26, a moving picture, of which the R, G and B images all have the full resolution and high frame frequencies, can be obtained. By synthesizing the respective images together, a color moving picture can be obtained.

The method for detecting the motion of the subject, generating interpolated frames for the G image, and increasing its frame frequency, based on the Cy, Mg and Ye images that are supplied with high frame frequencies is the same as what has already been described with respect to the first preferred embodiment. The method for generating interpolated pixels for the Cy, Mg and Ye images, and increasing their resolutions, based on the G image that has been supplied with the full resolution may also be the same as what has already been described for the first preferred embodiment. That is to say, the method for generating interpolated pixels for the R and B images, and increasing their resolutions, based on the G image that has been supplied with the full resolution may be used as in the first preferred embodiment described above.

According to this preferred embodiment, a solid-state image sensor with good sensitivity is realized, although its color reproducibility is somewhat inferior to the one that uses the three primary colors.

### Embodiment 4

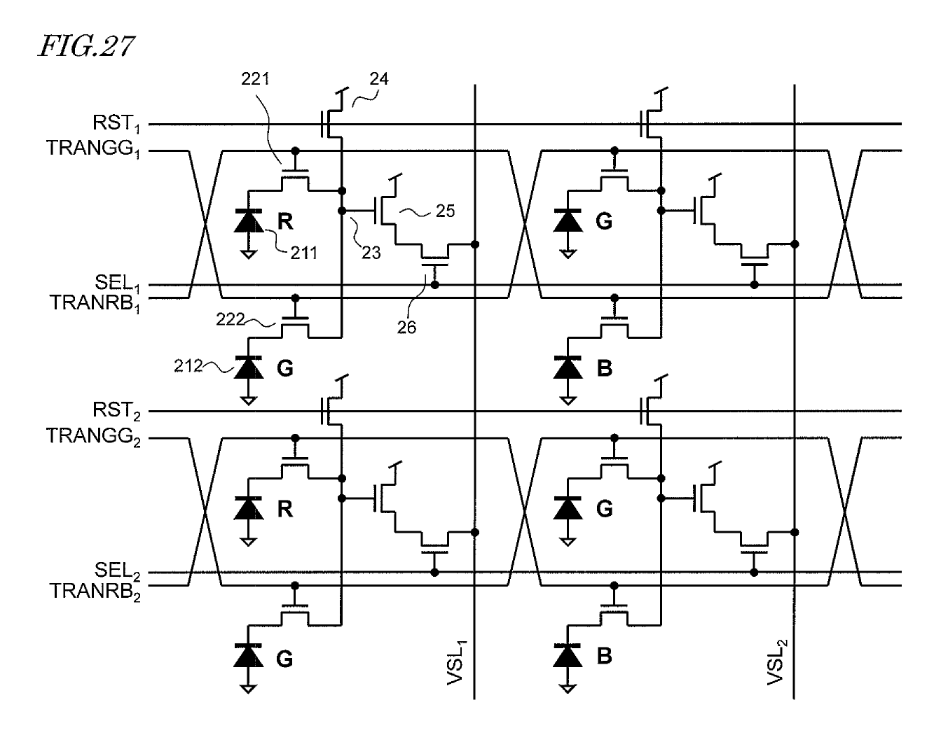

FIG. 27 is a diagram illustrating a pixel circuit consisting of four rows and two columns of pixels in a solid-state image sensor as a fourth preferred embodiment of the present invention. This solid-state image sensor has a so-called “two pixels in one cell” structure. That is to say, two photodiodes 211 and 212 and two transfer transistors 221 and 222 are arranged in each pixel, and each pair of vertically adjacent pixels shares the same reset transistor 23, the same output transistor 24 and the same select transistor 25.

In the solid-state image sensor of this preferred embodiment, each photodiodes 211, 212, which is a photoelectric transducer, includes an R, G or B color filter on its light incident surface and converts an incoming light ray falling within the R, G or B wavelength range into a quantity of charge in proportion to the intensity of the incoming light ray as in the first preferred embodiment described above. The pixels are arranged two-dimensionally to form a matrix pattern. The gate terminals that control the reset transistors 24 of a group of pixels that are arranged in the row direction are connected in common to the same control signal line RST. Likewise, the gate terminals that control the select transistors 26 of a group of pixels that are arranged in the row direction are also connected in common to the same control signal line SEL. On the other hand, the gate terminals that control the transfer transistors 221 and 222 of the R, G and B pixels are connected to control signal lines TRANRB and TRANGG, which are arranged so as to cross each other in the row direction.

The peripheral circuits have the same configuration as their counterparts of the first preferred embodiment described above. Hereinafter, a pixel driving method, which characterizes this preferred embodiment, will be described.

Specifically, when shooting a subject with high illuminance in a bright shooting environment, a group of G pixels is read with TRANGG activated and then a group of R pixels and a group of B pixels are read with TRANBB activated. These two read operations are performed vertically in this order. Although the group of G pixels is arranged on the solid-state image sensor so as to have a vertical zigzag pattern, G images output are arranged in the row direction. That is why the signal processor needs to perform address conversion and restore their original positions on the solid-state image sensor. Address conversion is also performed in the same way on the R and B pixels. As a result, R, G and B images with the full resolution are output every frame.

On the other hand, when shooting a subject with low illuminance in a dark shooting environment, the modes of operation are changed into a high sensitivity mode, in which pixel signals are read from R and B pixels every frame and from the group of G pixels every four frames, respectively. The read operation to be performed on the groups of R, G and B pixels every four frames may be the same as in the shooting in the bright environment described above. In frames in which pixel signals are read from only G pixels, just TRANGG of the two kinds of transfer transistor control lines is activated. The electrical charge that has been photoelectrically converted by the photodiode 212 of a G pixel moves to the gate of the output transistor 25 by way of the transfer transistor 222 and is transformed into a signal voltage due to the presence of a gate capacitance and a parasitic capacitance at the node 23. Then, by activating SEL, the select transistor 26 is turned ON and an electrical signal is output to the output terminal OUT. After the pixel signal has been output, the transfer transistor 222 and the select transistor 26 are turned OFF and RST is activated, thereby resetting the gate potential. By performing this series of operations vertically and sequentially, only G images are output from the group of pixels that are arranged in the matrix pattern and then subjected to the address conversion.

According to this preferred embodiment, the reset transistor, output transistor and select transistor are shared by multiple pixels, and therefore, the size of each pixel can be reduced. Consequently, a greater number of pixels can be integrated together.

### Embodiment 5

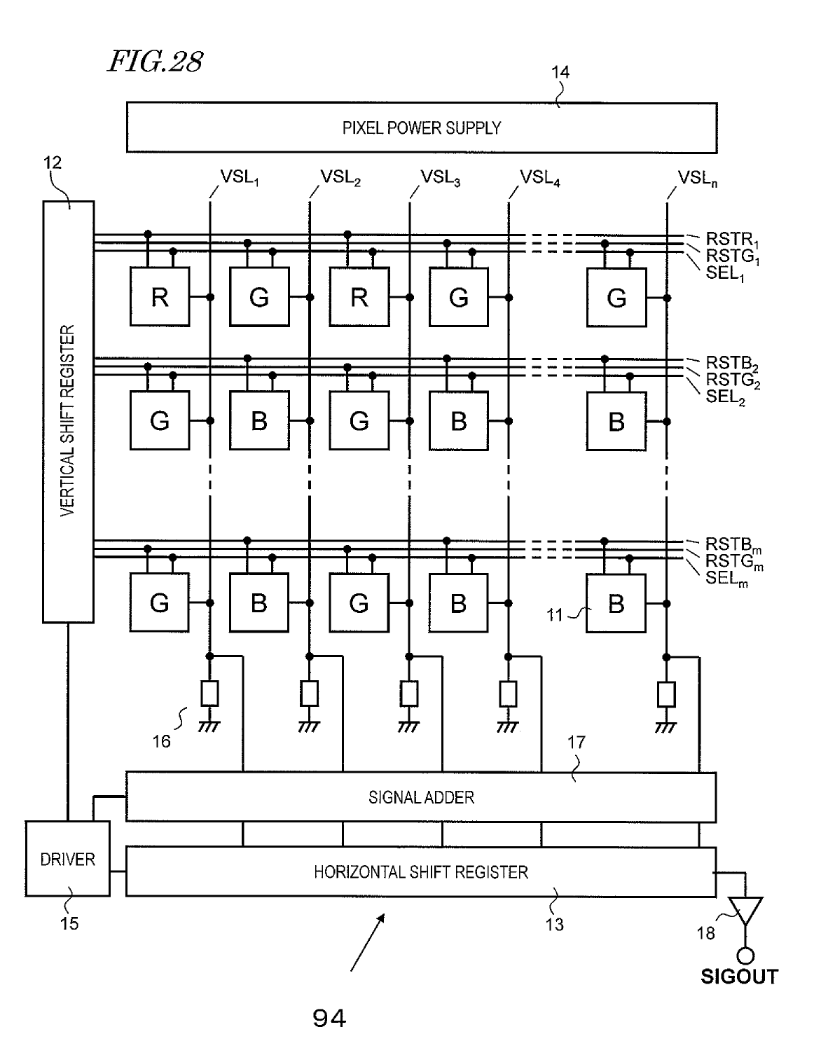

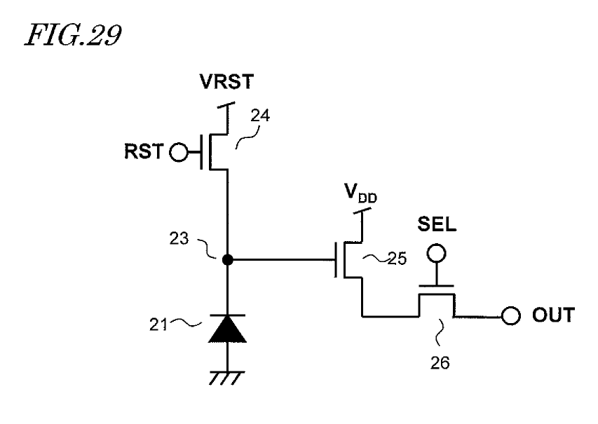

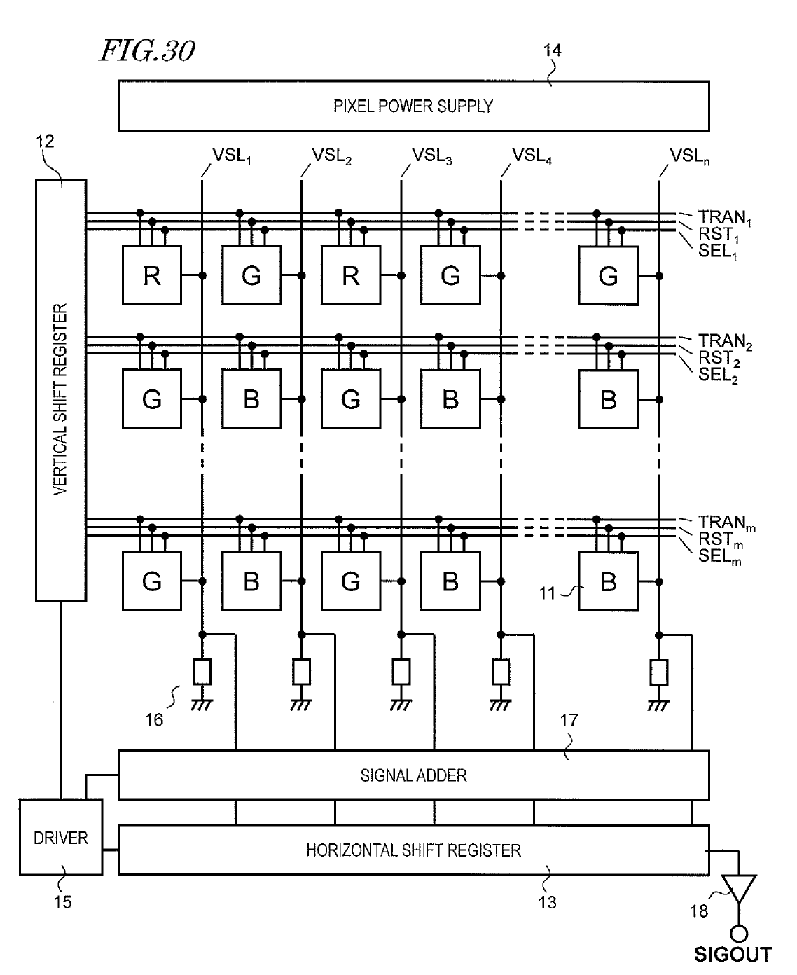

FIG. 28 illustrates a configuration for a solid-state image sensor 94 as a fifth preferred embodiment of the present invention. FIG. 29 is a circuit diagram for a pixel as a constituent element of the solid-state image sensor 94. The peripheral circuits have the same configurations as their counterparts of the first preferred embodiment described above. And this is a pixel circuit from which the transfer transistor has been omitted. Each photodiode 21, which is a photoelectric transducer, includes an R, G or B color filter on its light incident surface and converts an incoming light ray falling within the R, G or B wavelength range into a quantity of charge in proportion to the intensity of the incoming light ray. The gate terminals that control the select transistors 26 of a group of pixels that are arranged in the row direction are connected in common to the same control signal line SEL. The gate terminals RST that control R pixels, G pixels and the reset transistors 24 of the G pixels are connected to control signal lines RSTR, RSTG and RSTB, respectively, which are connected so as to run in the row direction. Hereinafter, a pixel driving method, which characterizes this preferred embodiment, will be described.

According to this preferred embodiment, the photodiode 21 and the gate of the output transistor 25 are directly connected together with no transfer transistor interposed between them. That is why the electrical charge that has been photoelectrically converted by the photodiode 21 is converted immediately into a signal voltage by the gate capacitance and the parasitic capacitance at the node 23.

When shooting a subject with high illuminance in a bright shooting environment, SEL is activated vertically and sequentially, thereby turning the select transistor 26 ON and outputting a pixel signal to the output terminal OUT. G and R pixel signals and G and B pixel signals are alternately read one row after another onto the vertical signal line VSL. After pixel signals have been read from each row, RSTG, RSTR and RSTG, RSTB are alternately activated, thereby resetting the gate potential. The horizontal shift register 17 transfers the pixel signals, which will then be amplified by the output amplifier 18 and then output to the output terminal SIGOUT. As a result of this operation, R, G and B images with the full resolution are output every frame.

On the other hand, when shooting a subject with low illuminance in a dark shooting environment, the modes of operation are changed into a high sensitivity mode, in which pixel signals are read from R and B pixels every frame and from a group of G pixels every four frames. Then, SEL is activated vertically and sequentially, thereby turning the select transistor 26 ON and outputting a pixel signal to the output terminal OUT. G and R pixel signals and G and B pixel signals are alternately read one row after another onto the vertical signal line VSL. After pixel signals have been read from each row, RSTR and RSTB are respectively activated, thereby resetting the gate potentials of R and B pixels. Likewise, after G pixel signals have been read, RSTG is activated, thereby resetting the gate potentials of the G pixels. The driver 15 activates the signal adder 17 to add together every four R pixels and every four B pixels. As a result, a G image with the full resolution is output every four frames and R and B images with a half vertical resolution and a half horizontal resolution are output every frame.

According to this preferred embodiment, the transfer transistor can be omitted, and therefore, the size of each pixel can be reduced. Consequently, a greater number of pixels can be integrated together.

In the solid-state image sensor of each of the preferred embodiments of the present invention described above, multiple different types of pixel groups are supposed to be arranged so as to form a two-dimensional matrix pattern. However, the “two-dimensional matrix pattern” is only an example. Alternatively, those multiple different types of pixel groups may form an image sensor with a honeycomb structure, for example.

The present invention can be used in any device for shooting a moving picture with a solid-state image sensor, which may be a camcorder, a digital still camera with the capability of shooting a movie, or a cellphone, to name just a few. Thus, the present invention can be used most effectively to capture a high-resolution, high-frame-frequency color image with high sensitivity.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. A solid-state image sensor comprising:
multiple different types of pixel groups, which exhibit mutually different sensitivity properties that vary from one group to another according to wavelengths of incoming light, wherein each said pixel has a photoelectric converter for outputting a pixel signal in accordance with intensity of the light received, and
a reading circuit, which reads the pixel signal from each of the multiple types of pixel groups and which outputs an image signal representing an image that is associated with the type of a pixel group,
wherein the reading circuit reads the pixel signal and outputs the image signal with the frame frequency changed according to the type of the pixel group.

2. The solid-state image sensor of claim 1, further comprising a signal adder for adding together multiple pixel signals that have been read from the same type of pixel group,
wherein the signal adder changes the number of the pixel signals to add together according to the type of the pixel group, thereby changing the spatial frequency of the image with the type of pixel group.

3. The solid-state image sensor of claim 1, wherein at least three types of pixel groups, which are included in the multiple different types of pixel groups, respectively have three photoelectric converters that exhibit the highest sensitivity to red, green and blue incident light rays, and
wherein two images that have been respectively read from a red pixel group that exhibits the highest sensitivity to the red light ray and from a blue pixel group that exhibits the highest sensitivity to the blue light ray have higher frame frequencies than an image that has been read from a green pixel group that exhibits the highest sensitivity to the green light ray.

4. The solid-state image sensor of claim 3, wherein the two images that have been respectively read from the red and blue pixel groups have lower spatial frequencies than the image that has been read from the green pixel group.

5. The solid-state image sensor of claim 1, wherein at least four types of pixel groups, which are included in the multiple different types of pixel groups, respectively have three photoelectric converters that exhibit the highest sensitivity to red, green and blue incident light rays and another photoelectric converter that exhibits high sensitivity over the entire visible radiation range, and
wherein an image that has been read from a white pixel group that exhibits the high sensitivity over the entire visible radiation range has a higher frame frequency than an image that has been read from any of red, blue and green pixel groups that exhibit the highest sensitivity to the red, blue and green light rays, respectively.

6. The solid-state image sensor of claim 5, wherein the image that has been read from the white pixel group has a lower spatial frequency than the image that has been read from any of the red, green and blue pixel groups.

7. The solid-state image sensor of claim 1, wherein at least four types of pixel groups, which are included in the multiple different types of pixel groups, respectively have a photoelectric converter that exhibits the highest sensitivity to the green incident light ray and three photoelectric converters that exhibit the highest sensitivity to incident light rays representing the three complementary colors of the three primary colors, and
wherein an image that has been read from any of three types of complementary color pixel groups representing the complementary colors has a higher frame frequency than an image that has been read from a green pixel group that exhibits the highest sensitivity to the green light ray.

8. The solid-state image sensor of claim 7, wherein the image that has been read from any of the three types of complementary color pixel groups has a lower spatial frequency than the image that has been read from the green pixel group.

9. A camera system comprising:
the solid-state image sensor of claim 1;
a motion detector for calculating the motion of a subject based on an image frame with a relatively high frame frequency that has been read from the solid-state image sensor; and
a restoration processor for generating an interpolated frame between image frames with a relatively low frame frequency that have been read from the solid-state image sensor.

10. The camera system of claim 9, wherein the restoration processor restores the shape of the subject using an image frame with a relatively high spatial frequency that has been read from the solid-state image sensor, and generates an interpolated pixel with respect to an image frame with a relatively low spatial frequency that has also been read from the solid-state image sensor.

11. The camera system of claim 9, further comprising a timing generating section for controlling the frame frequency of an image to be read according to the type of the pixel group by changing the operating frequency of a reading circuit that is reading the image with the brightness of the subject.

12. The camera system of claim 11, further comprising another timing generating section for controlling the spatial frequency of an image according to the type of the pixel group by changing the number of pixel signals to be added together by the signal adder with the brightness of the subject.

13. A method for reading an image signal from a solid-state image sensor with multiple different types of pixel groups, which exhibit mutually different sensitivity properties,
wherein each of the pixels that form the multiple different types of pixel groups has a sensitivity property that varies according to wavelengths of incoming light and also has a photoelectric converter for outputting a pixel signal in accordance with intensity of the light received, and
wherein the method comprises the steps of:
exposing the photoelectric converter with the exposure time changed according to the type of the pixel group;
reading the pixel signal from each of the multiple types of pixel groups, the pixel signal representing the intensity of light that has been received for one of multiple different exposure times; and
outputting an image signal representing an image according to what type of pixel group with the frame frequency changed according to the type of the pixel group.

14. The reading method of claim 13, further comprising the step of adding together multiple pixel signals that have been read from the same type of pixel group,
wherein the step of adding includes changing the number of pixel signals to add together according to the type of the pixel group, and
wherein the step of outputting an image signal includes outputting, based on the pixel signals that have been added together, an image signal representing an image, of which the spatial frequency varies according to the type of the pixel group.

15. The reading method of claim 13, wherein at least three types of pixel groups, which are included in the multiple different types of pixel groups, respectively have three photoelectric converters that exhibit the highest sensitivity to red, green and blue incident light rays, and
wherein red and blue pixel groups that exhibit the highest sensitivity to the red and blue light rays, respectively, have a shorter exposure time than a green pixel group that exhibits the highest sensitivity to the green light ray, and
wherein the step of outputting the image signal includes outputting image signals representing three images that have been read from the green, red and blue pixel groups, respectively, and
wherein the two images that have been respectively read from the red and blue pixel groups have higher frame frequencies than the image that has been read from the green pixel group.

16. The reading method of claim 15, further comprising the step of adding together multiple pixel signals that have been read from the same type of pixel group,
wherein as the step of adding includes changing the number of pixel signals to add together according to the type of the pixel group, the number of pixel signals that have been read from each of the red and blue pixel groups is larger than that of pixel signals that have been read from the green pixel group, and
wherein the two images that have been respectively read from the red and blue pixel groups have lower spatial frequencies than the image that has been read from the green pixel group.

17. The reading method of claim 13, wherein at least four types of pixel groups, which are included in the multiple different types of pixel groups, respectively have three photoelectric converters that exhibit the highest sensitivity to red, green and blue incident light rays and another photoelectric converter that exhibits high sensitivity over the entire visible radiation range, and
wherein red, blue and green pixel groups that exhibit the highest sensitivity to the red, blue and green light rays, respectively, have a shorter exposure time than a white pixel group that exhibits the high sensitivity over the entire visible radiation range, and
wherein the step of outputting the image signal includes outputting image signals representing four images that have been read from the green, red, blue and white pixel groups, respectively, and
wherein the respective images that have been read from the red, blue and green pixel groups have higher frame frequencies than the image that has been read from the white pixel group.

18. The reading method of claim 17, further comprising the step of adding together multiple pixel signals that have been read from the same type of pixel group,
wherein as the step of adding includes changing the number of pixel signals to add together according to the type of the pixel group, the number of pixel signals that have been read from each of the red, blue and green pixel groups is larger than that of pixel signals that have been read from the white pixel group, and
wherein the three images that have been respectively read from the red, blue and green pixel groups have lower spatial frequencies than the image that has been read from the white pixel group.

19. The reading method of claim 13, wherein at least four types of pixel groups, which are included in the multiple different types of pixel groups, respectively have a photoelectric converter that exhibits the highest sensitivity to the green incident light ray and three photoelectric converters that exhibit the highest sensitivity to incident light rays representing the three complementary colors of the three primary colors, and
wherein three types of complementary color pixel groups that are associated with the three complementary colors, respectively, have a shorter exposure time than the green pixel group that exhibits the highest sensitivity to the green light ray, and
wherein an image that has been read from any of the three types of complementary color pixel groups has a higher frame frequency than an image that has been read from the green pixel group.

20. The reading method of claim 19, further comprising the step of adding together multiple pixel signals that have been read from the same type of pixel group,
wherein as the step of adding includes changing the number of pixel signals to add together according to the type of the pixel group, the number of pixel signals that have been read from each of the three types of complementary color pixel groups is larger than that of pixel signals that have been read from the green pixel group, and
wherein the three images that have been respectively read from the three types of complementary color pixel groups have lower spatial frequencies than the image that has been read from the green pixel group.

21. A signal processing method to be performed by a signal processor in a camera system that includes:
multiple different types of pixel groups, which exhibit mutually different sensitivity properties that vary from one group to another according to wavelengths of incoming light, wherein each said pixel has a photoelectric converter for outputting a pixel signal in accordance with intensity of the light received; and
the signal processor for processing an image that has been read from the solid-state image sensor,
wherein the method comprises the steps of:
calculating the motion of a subject based on an image with a high frame frequency that has been read from the solid-state image sensor by the reading method of claim 13; and
generating an interpolated frame between images with a low frame frequency.

22. The signal processing method of claim 21, further comprising the steps of:
calculating the shape of the subject using the image with the high spatial frequency that has been read from the solid-state image sensor; and
interpolating a pixel with respect to the image with the low spatial frequency that has also been read from the solid-state image sensor based on the shape calculated.

23. The signal processing method of claim 21, further comprising the step of controlling the frame frequency on a pixel group basis by changing the exposure time with the type of the pixel group and according to the brightness of the subject.

24. The signal processing method of claim 23, further comprising the step of adding together multiple pixel signals that have been read from the same type of pixel group,
wherein the step of adding includes controlling the spatial frequency of an image according to what type of pixel group is going to be processed among the multiple types by changing the number of pixel signals to add together with the type of the pixel group and according to the brightness of the subject.
